(19) United States
(12) Patent Application Publication
(10) Pub. No.: US 2013/0304645 A1
(43) Pub. Date: Nov. 14, 2013

(54) AUTOMATED FUTURE COLLEGE FUND

(71) Applicant: Desiree Shank, Castle Rock, CO (US)

(72) Inventor: Desiree Shank, Castle Rock, CO (US)

(21) Appl. No.: 13/890,119

(22) Filed: May 8, 2013

Related U.S. Application Data
(60) Provisional application No. 61/632,840, filed on May 8, 2012.
(60) Provisional application No. 61/681,038, filed on Aug. 8, 2012.

(51) Int. Cl. G06Q 20/10

(52) U.S. Cl. CPC G06Q 20/108
USPC 705/42

(57) ABSTRACT

An online automated system enables users to automatically receive contributions and/or donations to their own or a beneficiary's college savings account with the click of an online button, which is linked to their college savings account through a secure payment facilitator such as WePay or PayPal. The users account information is set up and saved securely. This allows donations and/or contributions to be easily sent to the beneficiary's college savings account from anyone that clicks the button, such as family members or friends. This method makes it much simpler and automatic with the click of an online button to contribute/donate directly to the college savings account without having to know the account number of the college savings account, write a check, and mail it in.

### CROSS-REFERENCES TO RELATED APPLICATIONS

This application claims the benefit of U.S. Provisional Application Ser. No. 61/632,840 filed on May 8, 2012 titled “Future College Fund (FutureCollegeFund.com)” and U.S. Provisional Application Ser. No. 61/681,038 filed on Aug. 8, 2012 titled “Automated Future College Fund,” both of which are incorporated herein by reference in their entirety for all that is taught and disclosed therein.

### BACKGROUND

The disclosure generally relates to helping individuals reach a financial goal by provisioning web-based tools for receiving and leveraging contributions from many individuals or entities.

### SUMMARY

This Summary is provided to introduce in a simplified form a selection of concepts that are further described below in the Detailed Description. This Summary is not intended to identify key or essential features of the claimed subject matter, nor is it intended to be used to limit the scope of the claimed subject matter.

The detailed description below describes an online automated system called Automated Future College Fund that enables users to automatically receive contributions and/or donations to their own or a beneficiary's 529 savings account with the click of an online button displayed on a website, which is linked to their 529 account through a secure payment facilitator such as WePay or PayPal. The users account information is set up and saved securely. This allows donations and/or contributions to be easily sent to the beneficiary's 529 account from anyone that clicks the button on the website, such as family members or friends. The only current way to contribute to a 529 account is to hand write a check and deposit it or mail it to the correct bank or investment firm with the account holders name and account number on the check. The solution described below makes it much simpler and automatic with the click of an online button to contribute/donate directly to the 529 account without having to write a check and mail it in.

### BRIEF DESCRIPTION OF THE SEVERAL VIEWS OF THE DRAWINGS

FIGS. 1-25 show screen captures of various pages from a web site associated with an embodiment of the Automated Future College Fund of the present disclosure.

FIG. 26 shows a schematic/block diagram of an operating environment of an embodiment of the automated future college fund of the present disclosure.

FIG. 27 shows a flow diagram of a method of implementing an embodiment of the automated future college fund of the present disclosure.

FIG. 28 shows a schematic/block diagram of an operating environment of an embodiment of the automated future college fund of the present disclosure.

FIG. 29 shows a flow diagram of a method of implementing an embodiment of the automated future college fund of the present disclosure.

FIG. 30 shows a schematic/block diagram of another operating environment of an embodiment of the automated future college fund of the present disclosure.

FIG. 31 shows a flow diagram of a method of implementing an embodiment of the automated future college fund of the present disclosure.

### DETAILED DESCRIPTION

The invention may be implemented as a computer, a computing system, or as an article of manufacture such as a computer program product. The computer program product may be a computer storage medium readable by a computer system and encoding a computer program of instructions for executing a computer process.

With the computing environment in mind, embodiments of the present invention are described with reference to logical operations being performed to implement processes embodying various embodiments of the present invention. These logical operations are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts or modules may be implemented in software, firmware, special purpose digital logic, and any combination thereof without deviating from the spirit and scope of the present invention as recited within the claims attached hereto.

In one embodiment of the Automated Future College Fund, a website named FutureCollegeFund.com enables a user to sign up and register to receive information on 529 college savings accounts. These are investment accounts that allow you to set aside money for your child's education and let it grow tax-free. The federal government will not tax withdrawals as long as the withdrawals are used for higher education. Any family can contribute to a 529 account regardless of income, and there's a lifetime maximum contribution (the amount varies from state to state, ranging from $235,000 to more than $300,000). An account can often be started with as little as $25 and the money in a 529 plan can be used at any accredited college or university in the country. The user can sign up and apply for a 529 college savings account for themselves or a beneficiary using an outside banking or investing institution that is recommended on the website. One such institution is FirstBank Holding Company of Lakewood, Colo. and their CollegeInvest Smart Choice College Savings Plan. Any other 529 college savings plan may be utilized provided that it is provisioned to receive deposits from third party pay accounts. Once the user or the user's beneficiary's 529 account is set up with the bank or investment firm, via online registration or by application, the user receives a 529 account number. The user then adds information, such as the routing number and 529 account number, to their WePay account, PayPal account, or any other compatible third party pay account.

Other types of savings accounts may also be used. An account established under the Uniform Transfers To Minors Act allows parents to invest and deduct up to $12,000 a year with no limit on the maximum amount contributed to the account.

The Coverdell ESA college savings account allows all types of investments including cash. ESAs function very much like an IRA but for education purposes and not retirement. Contributions of up to $2,000 a year can be made with post-tax dollars. The money grows tax-free, and neither the contribution nor the interest is taxed when withdrawn, as long as the withdrawal is used for education purposes.

Prepaid tuition plans are investment accounts that allow a person to pay for their child's future college tuition (or a portion of it) at today's prices. If an individual or family has enough money now, they could pay for a complete four-year degree that their child won't use for another eighteen years. Or, if their budget is more modest, they can prepay a portion of their child's college expenses. Prepaid tuition plans are administered by individual states and most can only be redeemed at public colleges and universities in that state. In many cases, the parent(s) or the student beneficiary of the account must also live in that state. If the student opts to attend college out of state, prepaid tuition plans typically pay the average in-state rate and the family makes up any difference.

A custodial account is a savings account in a child's name that the parent(s) control (if the parent(s) are the custodian) until the child reaches legal adulthood (18 to 21 years of age, depending on the state residence). The custodian decides how much to put into the account, how the money is invested, how earnings are reinvested, and when to take money out to spend on the child's behalf. Cash, savings bonds, and other securities can be deposited in a custodial account.

A traditional IRA and a Roth IRA are investment accounts that allow individuals to save money for retirement or college while avoiding significant taxes. Traditional IRAs come in two forms—deductible and nondeductible. Eligibility for a traditional deductible IRA depends on the individual's income and whether the individual's employer has a retirement plan. In a deductible IRA, the annual contributions are tax deductible, but when money is withdrawn from the account, both the contributions and the earnings from the account are taxed. In a Roth IRA, contributions are not tax deductible, but earnings are tax-free if withdrawn after the required five-year holding period and the money is used for qualified expenses such as college tuition. The first $850 of earnings each year are tax-free, and the next $850 are taxed annually at the child's rate—generally fifteen percent. Any earnings beyond that are taxed at the parent's rate. Withdrawals are subject to federal tax as well.

Any of these savings vehicles can be used provided that they are compatible with the operating environments described below.

Once this is set up, the user in one embodiment purchases a donation website template from FutureCollegeFund.com. The user fills out a form on FutureCollegeFund.com and enters their beneficiary's name, typically their child or grandchild's name, and may upload the child or grandchild's photograph(s) and also fills in their email address associated with their third party pay account. The personal donation website is created by FutureCollegeFund.com displaying the child's name, photo(s) and a donation button on the webpage that can be labeled anything such as “College Fund,” “Donate Now,” “Fund It!,” etc., that links to the 529 account through a secure payment facilitator, such as WePay, PayPal, etc. The personal donation website receives a unique URL that the user can share with friends and family that typically takes the form of vvww.futurecollegefund.com/“Child'sName”. This personal donation website can now be shared with anyone and can receive donations from anyone directly to the 529 account associated with the personal donation website through the secure third party pay account. The donor/contributor donates money online directly from the donate button on the website to the 529 account. There is no longer any need for a donor to write a check and no confusion regarding where to send the check or to know the 529 account number associated with the account holder's name. Everything is now done online through the website and the FutureCollegeFund.com domain. Neither the 529 account number nor any personal information besides an email and billing information for the purchase of the donation website is used by FutureCollegeFund.com.

In one embodiment, there is no fee assessed to a user to set up their donation website. FutureCollegeFund.com will charge a 2% fee on all donations to each 529 account. If the donor utilizes a credit card, a 3% credit card fee assessed on donations will be paid to the credit card companies.

Parents are the most likely users to set up donation websites on behalf of their children. However, aunts and uncles may also set up donation websites on behalf of nephews and nieces. Grandparents and godparents may also set donation websites on behalf of their grandchildren and godchildren.

Financial advisors may work with their clients in establishing donation websites through FutureCollegeFund.com. Financial professionals can pay a small annual fee to join a FutureCollegeFund.com network. When a new user subscribes to Future College Fund that resides in the subscribing financial professional's licensed area, the financial professionals will be notified. A bidding system allows competing financial professionals to obtain the lead from FutureCollegeFund.com. The financial professional that bids the highest amount will be awarded with the user's contact information. Furthermore, the user will be notified that a financial professional will be in contact with them soon. This is a lucrative investment for financial professionals, as it is rare that 529 accounts are the only financial product that the users need or will be interested in. The addition of financial professionals is accomplished by direct sales efforts by FutureCollegeFund.com.

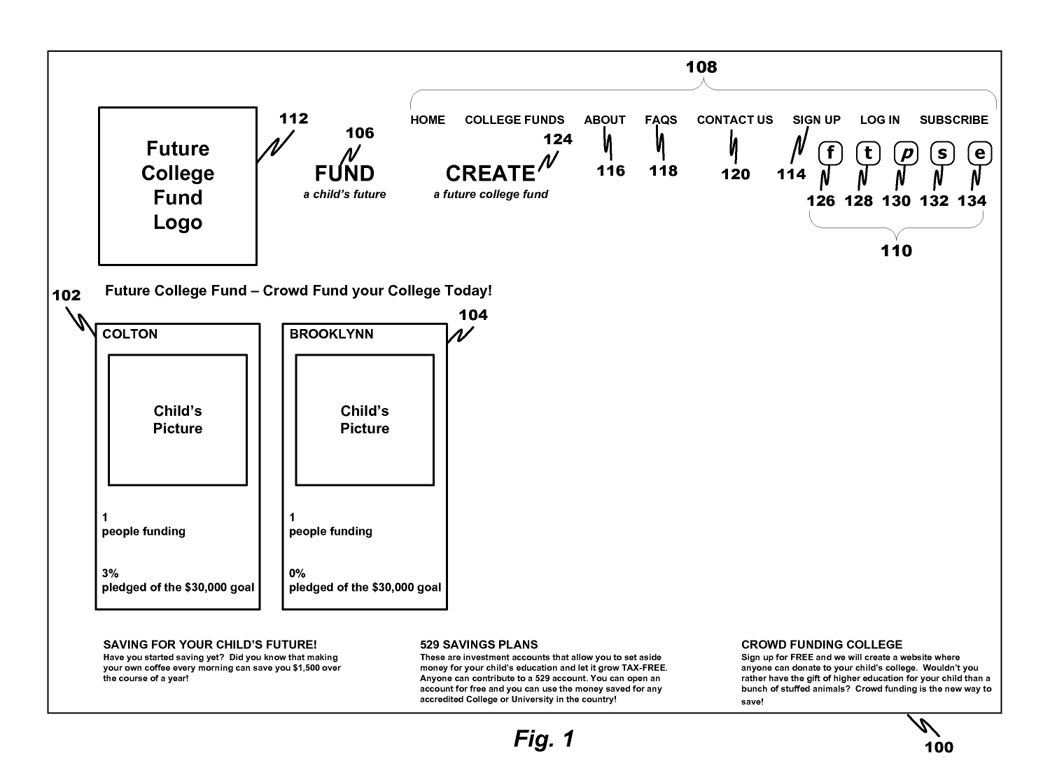

Referring now to the Figures, like reference numerals and names refer to structurally and/or functionally similar elements thereof, and if objects depicted in the figures that are covered by another object, as well as the tag line for the element number thereto, may be shown in dashed lines. FIGS. 1-25 show screen captures of various web pages from a web site associated with an embodiment of the Automated Future College Fund of the present disclosure. In most instances, the top menu bars and bottom menu bars typically displayed on web pages are omitted from the screen captures for simplicity. In addition, the web page shown may be truncated as only so much of a long web page may be viewable in the displayable area of the display device.

Referring now to FIG. 1, a potential user or interested person has navigated to www.FutureCollegeFund.com using an Internet browser loaded on an electronic device, such as a desktop, laptop, or tablet computer; smart phone; or any other suitable electronic device capable of accessing the Internet. Home Page 100 is displayed on the display device associated with the user's electronic device. One or more Featured Children 102, 104 are displayed. Featured Children 102, 104 represent personal donation websites that have already been set up and the users associated with those personal donation websites have given permission to FutureCollegeFund.com domain to display Featured Children 102, 104 on Home Page 100. Clicking on the Fund Link 106 will display a new web page (not shown) that may display a number of Featured Children 102, 104, . . . , xxx. The potential user or interested party may click on any of the Featured Children 102, 104, . . . , xxx links and be directed to the website for the Featured Children xxx clicked on. The potential user or interested party may make a contribution to the 529 account associated with the Featured Children xxx selected. Menu Bar 108 has multiple links that when clicked on will return different web pages. Home page 100 also has Icon Bar 110 with multiple icons that when clicked on allow the potential user to perform different functions that will be described below. Logo Block 112 contains the logo for Future College Fund.

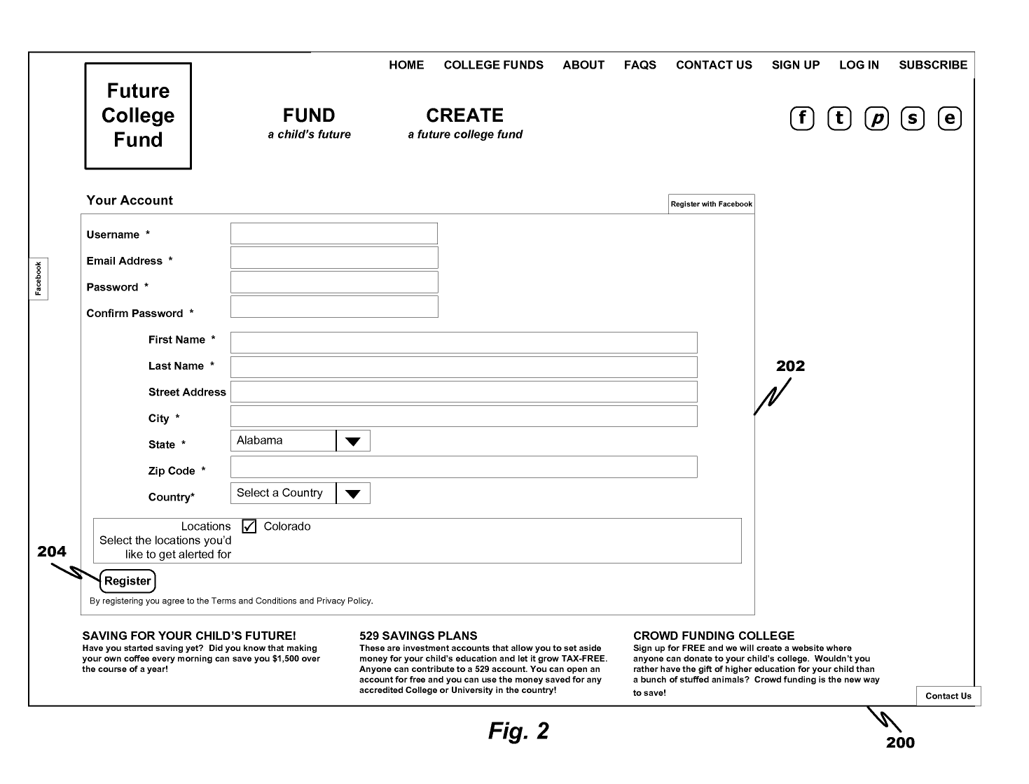

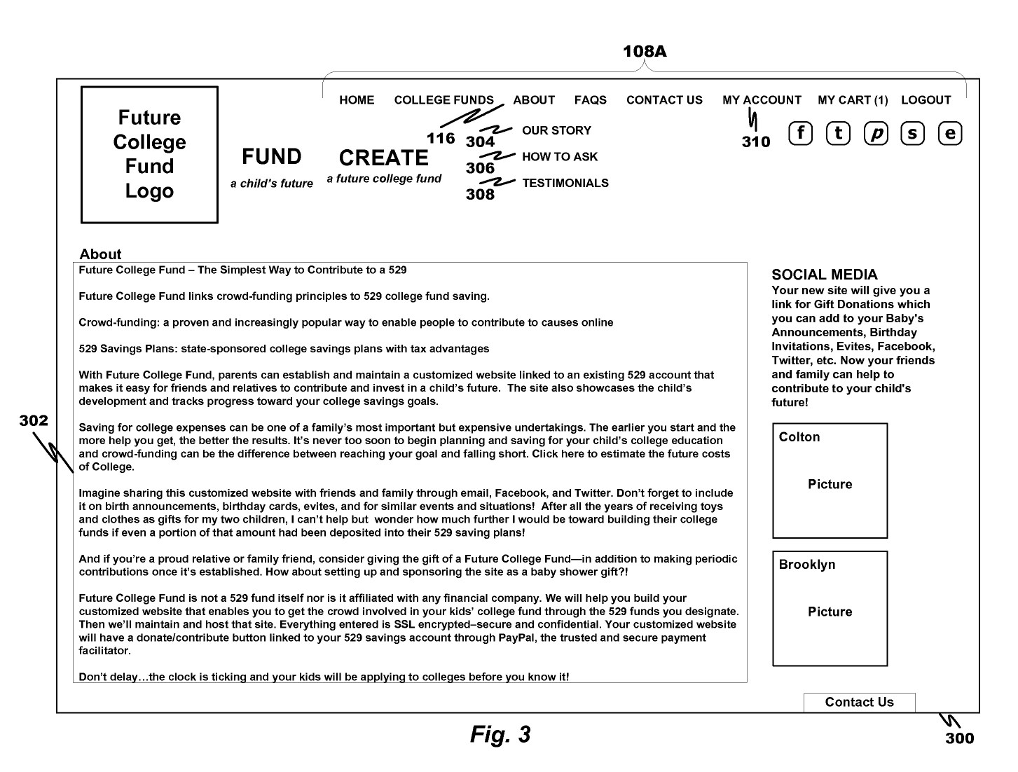

A potential user who is interested in setting up a Future College Fund for themselves or another person, such as their sibling, child, or grandchild can click on Sign Up Link 114, which will return Your Account Page 200 shown in FIG. 2. User Information Block 202 has a number of text entry boxes that the potential user can fill in by clicking in each box and typing in the information requested, including, but not limited to: Username; Email Address; Password; Confirm Password; First Name; Last Name; Street Address; City; State (which can be selected from a drop-down list); Zip Code; and Country (which can be selected from a drop-down list). Once all of the information has been typed in, the potential user can click on Register Button 204, which will register the user with FutureCollegeFund.com domain and return the user to Home Page 100, which now has an expanded Icon Bar 108A as shown in FIG. 3. In FIG. 3, the user has clicked on the About Link 116 which returns About Page 300. About Block 302 provides information about Future College Fund. The user has also hovered the mouse pointer over About Link 116 which reveals a pull-down list containing Our Story Link 304, How To Ask Link 306, and Testimonials Link 308.

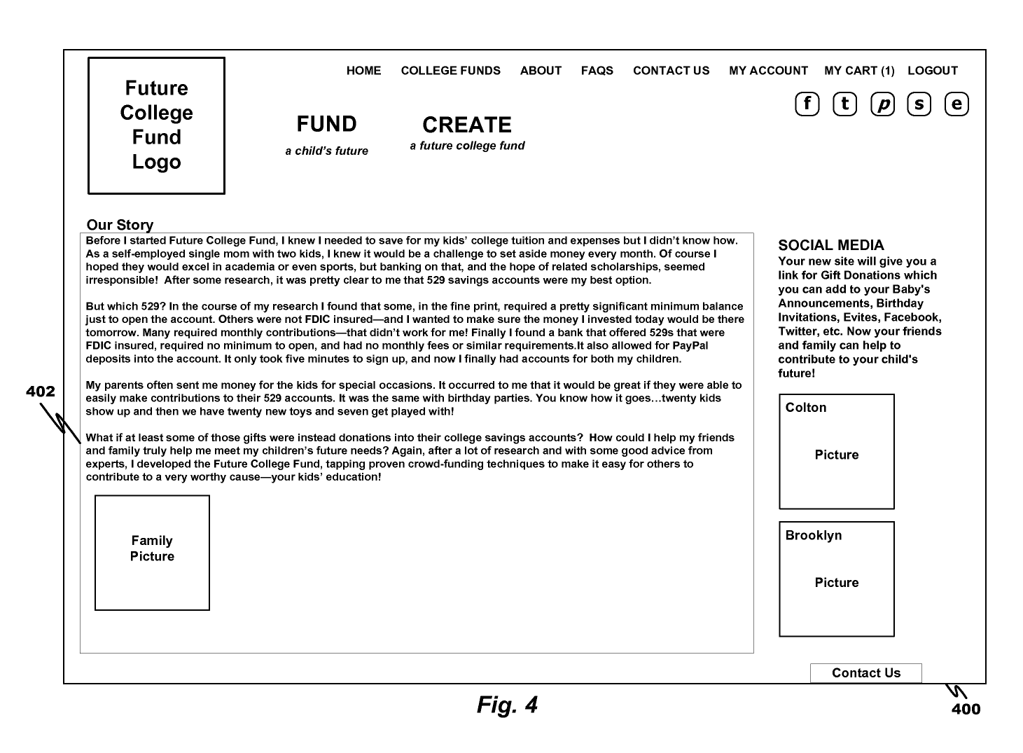

Clicking on Our Story Link 304 returns Our Story Page 400 shown in FIG. 4. Our Story Page 400 has Our Story Block 402 which provides the user with the Future College Fund founder's story.

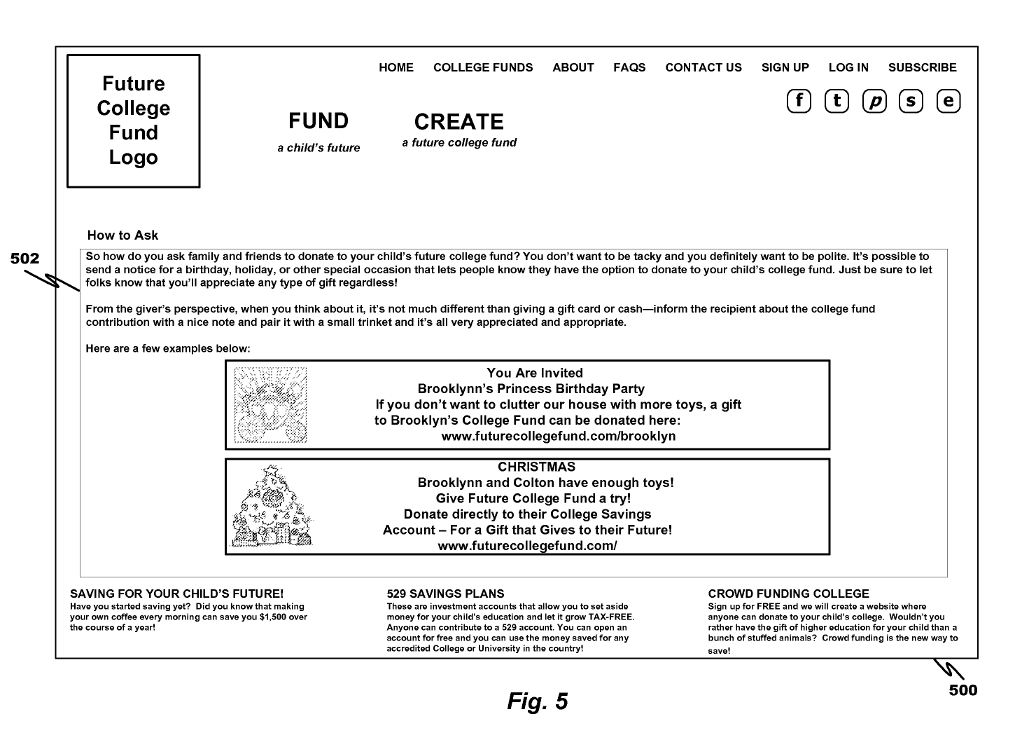

Clicking on How To Ask Link 306 returns How To Ask Page 500 shown in FIG. 5. How To Ask Page 500 has How To Ask Block 502 which provides the user with suggestions and examples of how to ask others to donate to the future college fund of the beneficiary of the user (such as the user's child or grandchild).

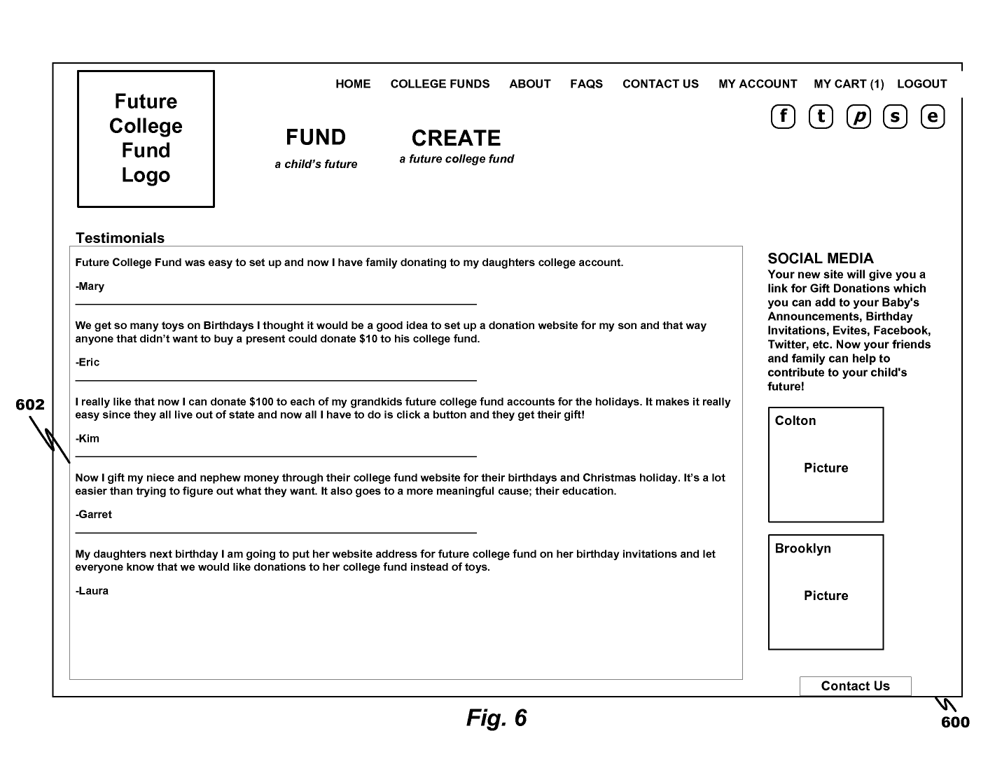

Clicking on Testimonials Link 308 returns Testimonials Page 600 shown in FIG. 6. Testimonials Page 600 has Testimonials Block 602 which provides the user with testimonials from other individuals who have signed up and created a donation website with Future College Fund.com.

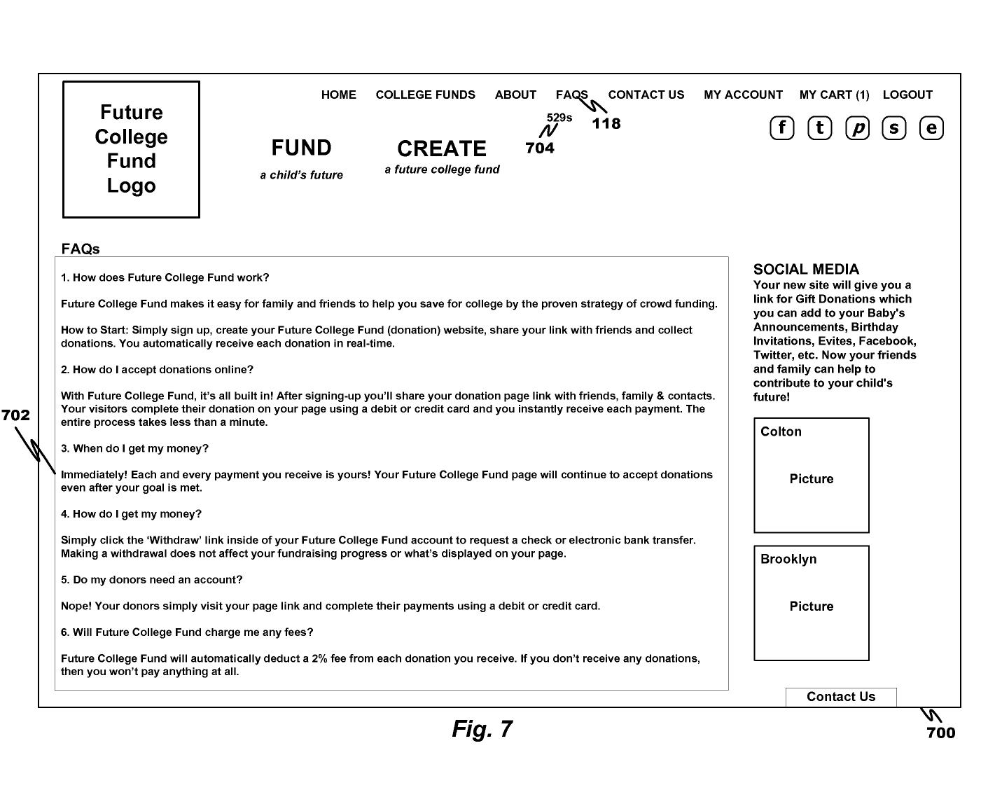

Clicking on FAQs Link 118 (FIG. 1) returns FAQs Page 700 shown in FIG. 7. FAQs Page 700 has FAQs Block 702 which provides the user with answers to frequently asked questions. The user has also hovered the mouse pointer over FAQs Link 118 which reveals a pull-down list containing 529sLink 704.

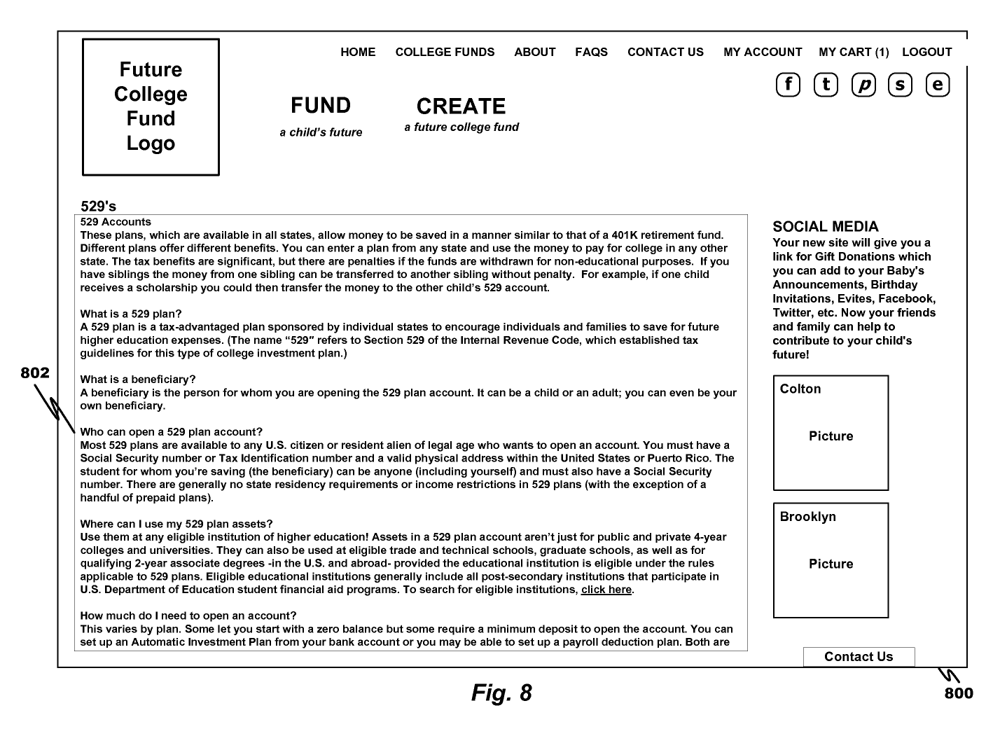

Clicking on 529sLink 704 returns 529sPage 800 shown in FIG. 8. 529sPage 800 has 529sBlock 802 which provides the user with information about 529 accounts.

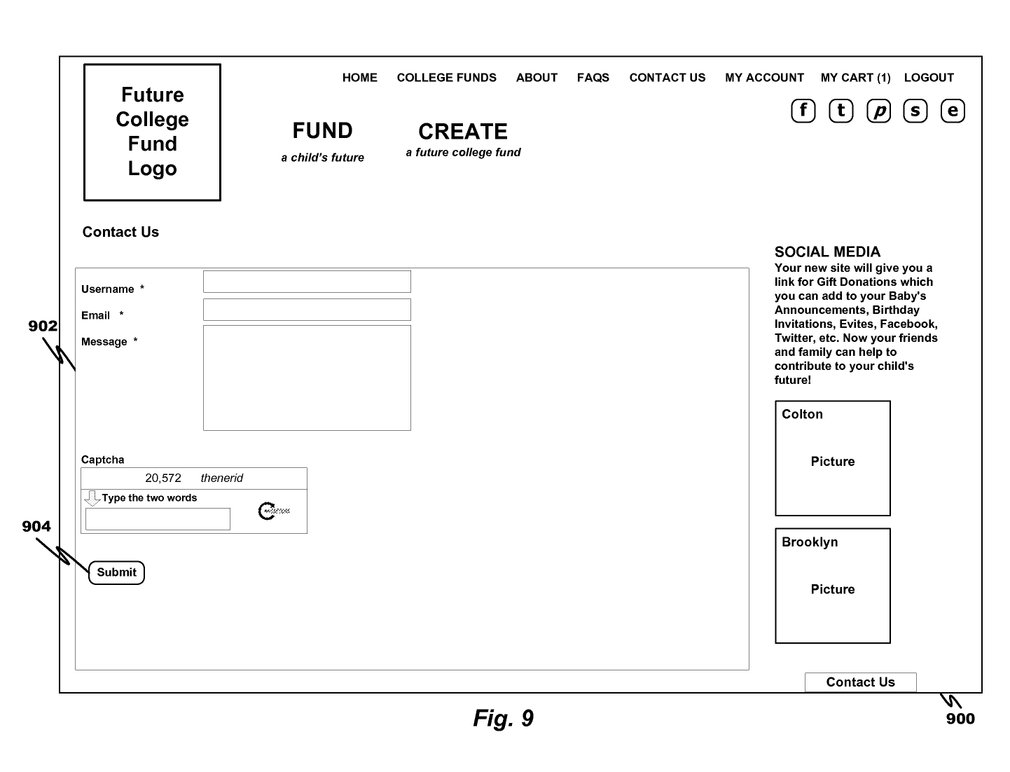

Clicking on Contact Us Link 120 (FIG. 1) returns Contact Us Page 900 shown in FIG. 9. Contact Us Page 900 has Contact Us Block 902 which has a number of text entry boxes that the user can fill in by clicking in each box and typing in the information requested, including, but not limited to: Name; Email; Message; and Captcha Text Box. Once all of the information has been typed in, the user can click on Submit Button 904 to contact the FutureCollegeFund.com domain.

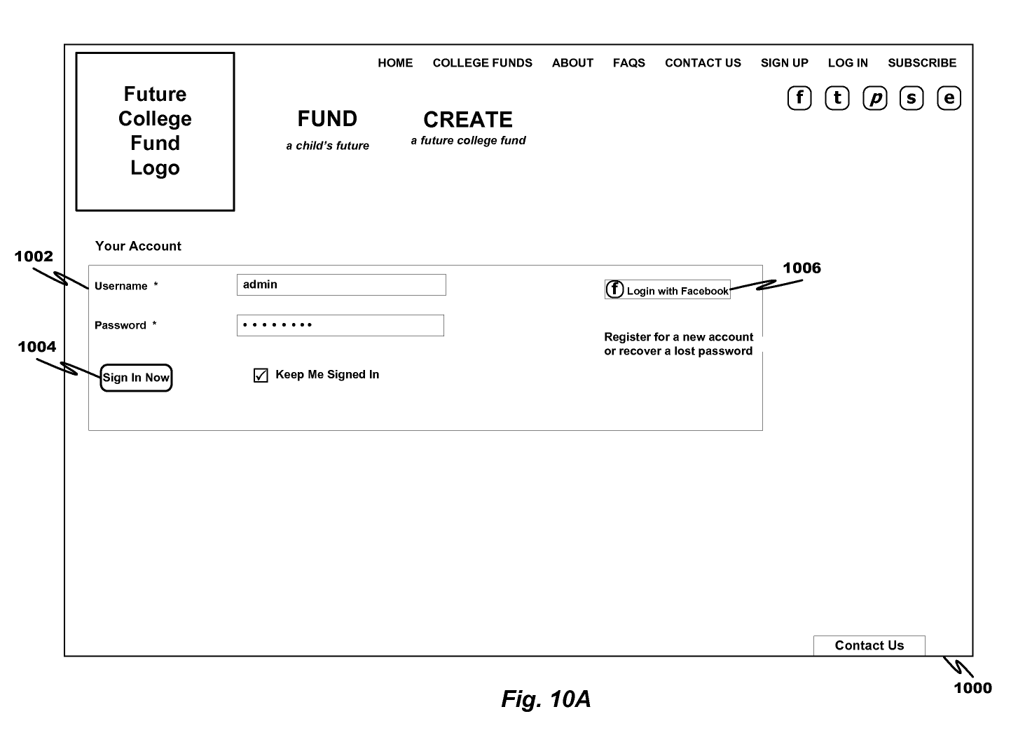

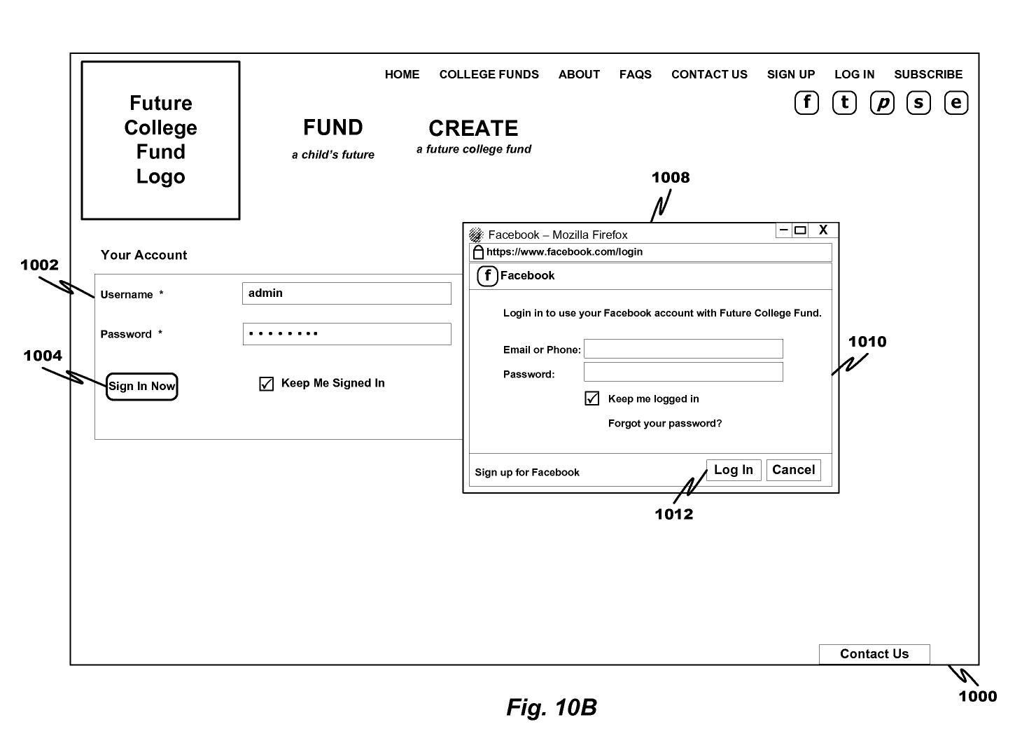

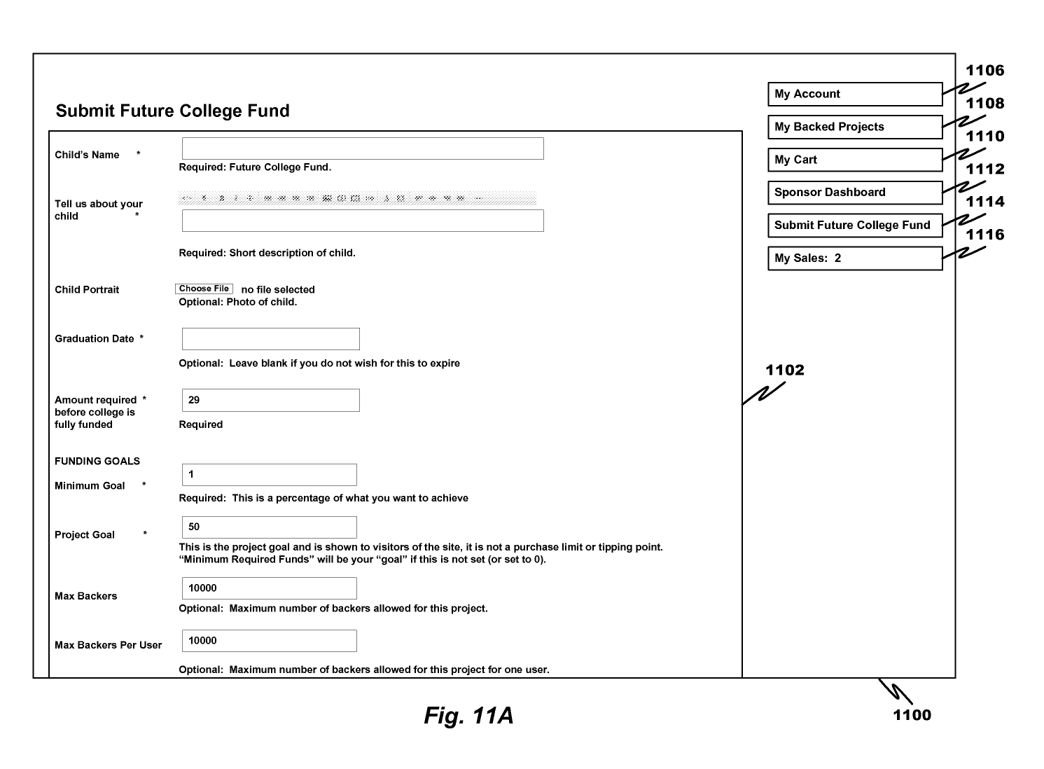

Clicking on Log In Link 122 (FIG. 1) returns Your Account Page 1000 shown in FIG. 10A. Your Account Page 1000 has Your Account Block 1002 which has a number of text entry boxes that the user can fill in by clicking in each box and typing in the information requested, including, but not limited to: Username and Password. Clicking on Sign In Now Button 1004 will sign in the user to their Future College Fund account. Or, the user can click on Login With Facebook Button 1006 which will return Facebook Pop Up Window 1008 as shown in FIG. 10B. Facebook Block 1010 has a number of text entry boxes that the user can fill in by clicking in each box and typing in the information requested, including, but not limited to: Phone or Email and Password. Clicking on Log In Button 1012 will sign in the user to their Future College Fund account via Facebook.

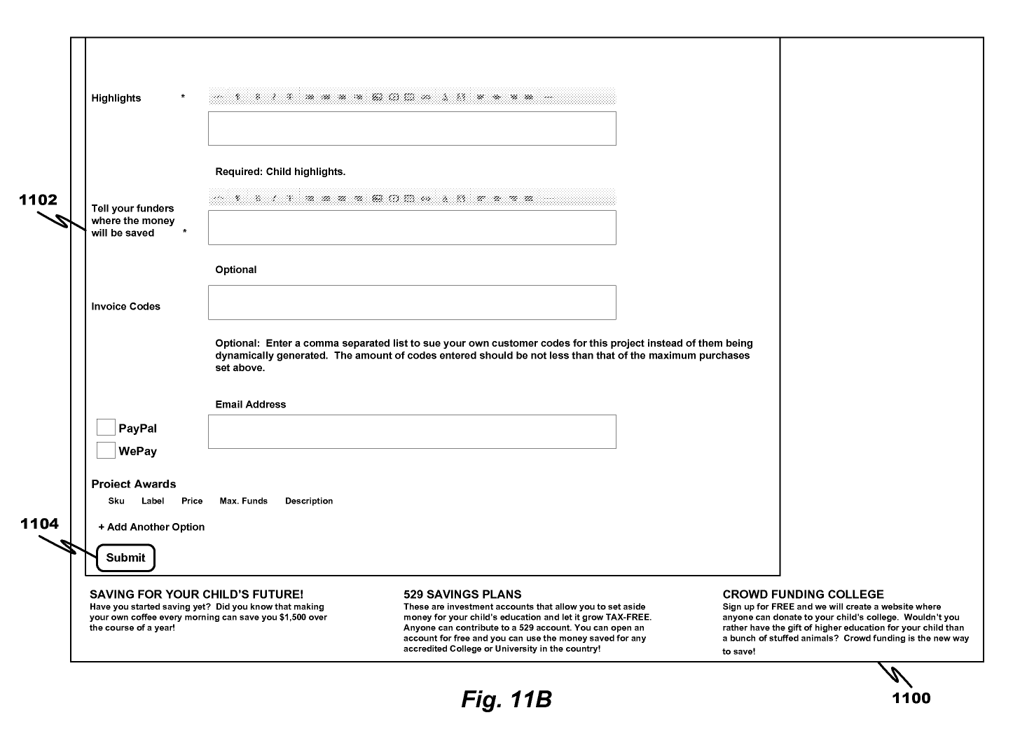

Once the user has registered (FIG. 2) and has logged in (FIG. 10A or 10B), the user can click on Create Link 124 (FIG. 1) which returns Submit Future College Fund Page 1100 shown in FIGS. 11A and 11B. Submit Future College Fund Page 1100 has Submit Block 1102 which has a number of text entry boxes that the user can fill in by clicking in each box and typing in the information requested, including, but not limited to: Child's Name; Tell us about your child; Child Portrait; Graduation Date; Amount required before college is fully funded; Minimum Goal; Project Goal; Max Backers; Max Backers Per User; Highlights; Tell your funders where the money will be saved; and Invoice Codes. Clicking on Submit Button 1104 will submit the information to FutureCollegeFund.com domain. An administrator at FutureCollegeFund.com domain will check the information and determine whether the information submitted is legitimate. If approved, an email is sent to the user indicating that their submission has been approved and that an account has been set up. In the email, the URL for the donation website is included, having the form of www.futurecollegefund.com/“Child'sName”.

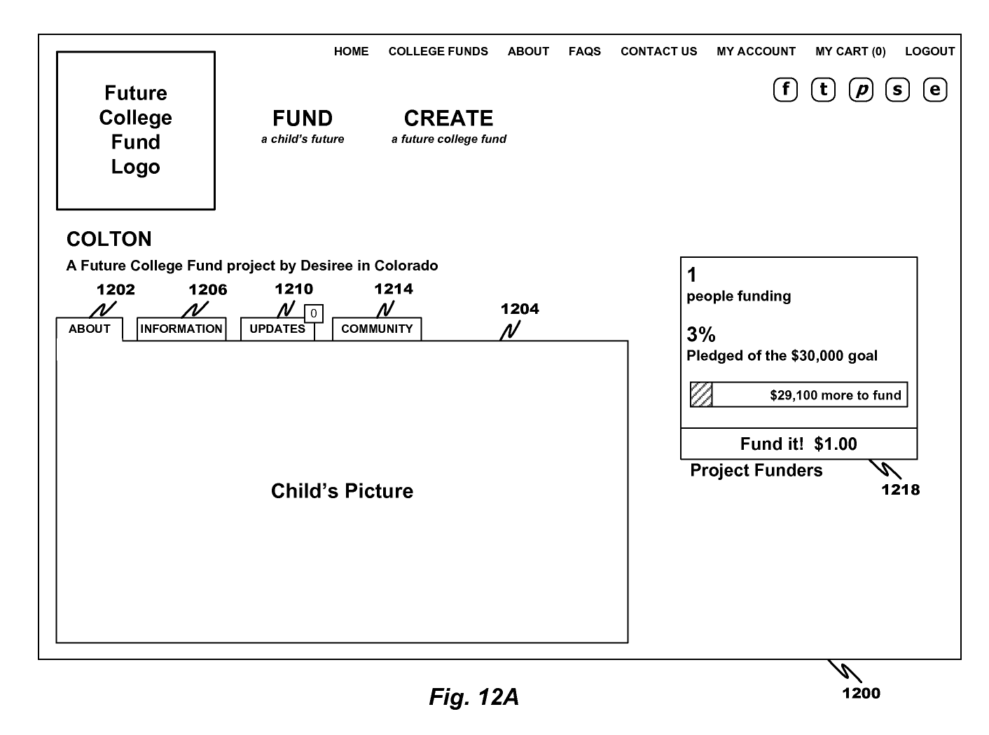

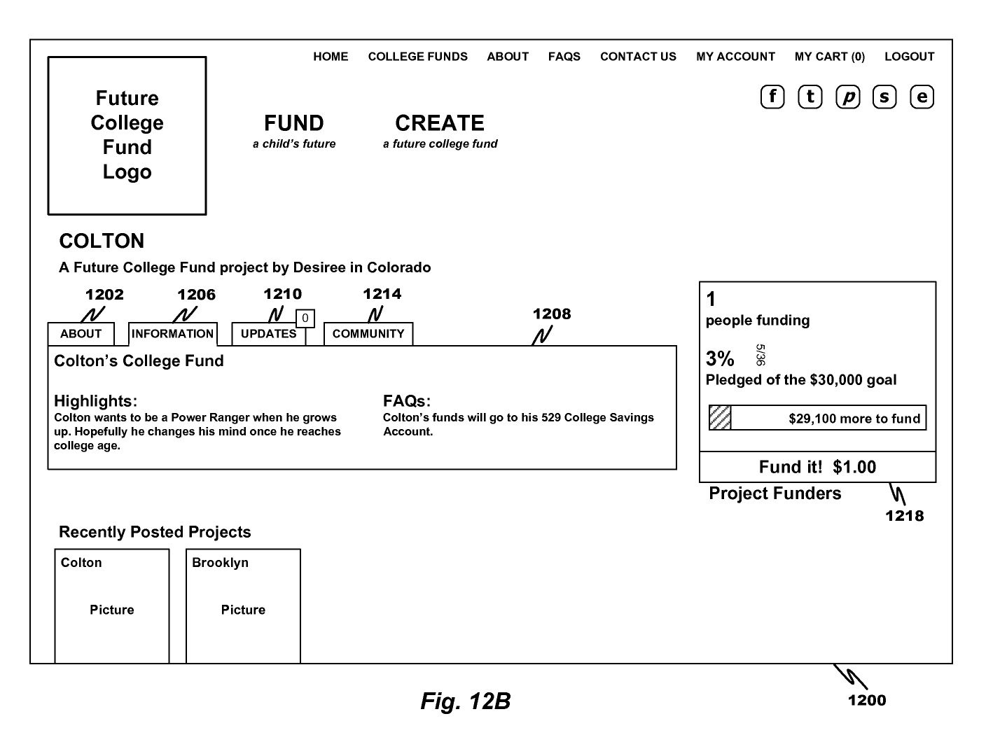

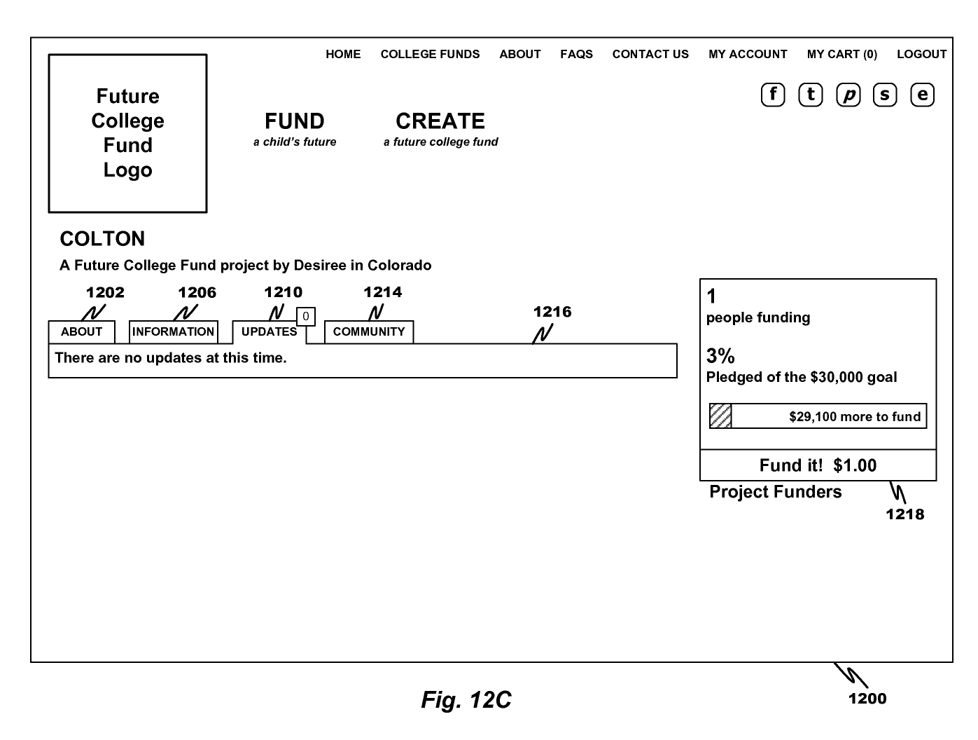

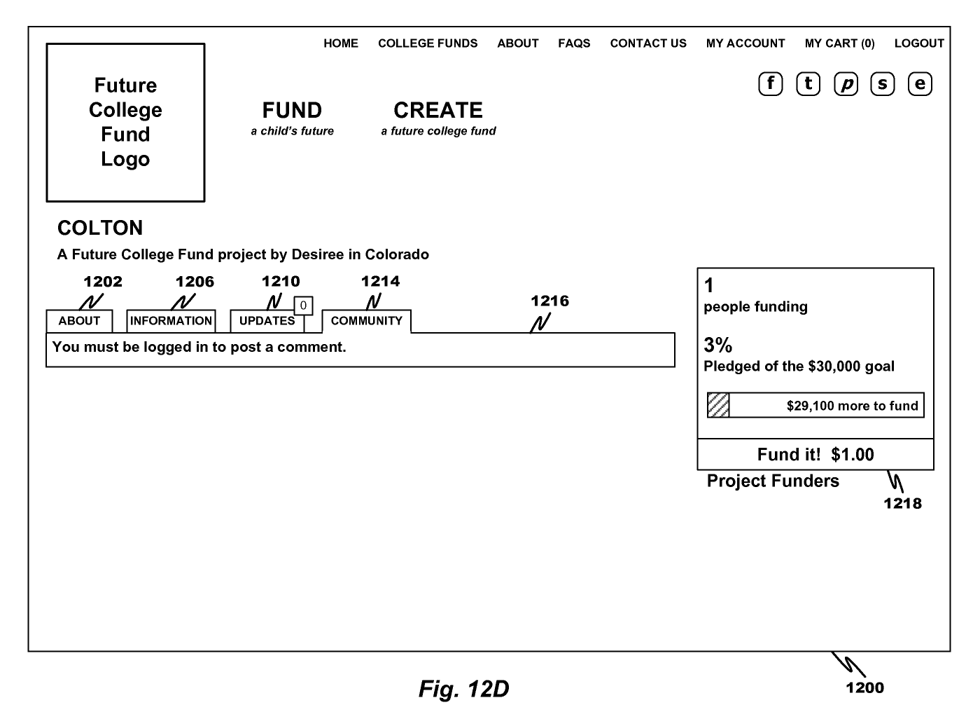

The user, or an interested third party referred to as a donor, can type the URL received in the email into their web browser, which returns Donation Home Page 1200 shown in FIG. 12A. Donation Home Page 1200 has many of the same features and functions as Home Page 100. In Donation Home Page 1200 the About Tab 1202 is in focus and displays in About Block 1204 a picture of the child for whom the donation website has been created.

Clicking on Information Tab 1206 will hide About Block 1204 and reveal Information Block 1208 as shown in FIG. 12B. Information Block 1208 has information about the child's college fund.

Clicking on Updates Tab 1210 will hide Information Block 1208 and reveal Updates Block 1212 as shown in FIG. 12C. Updates Block 1212 has updates posted about the child.

Clicking on Communities Tab 1214 will hide Updates Block 1212 and reveal Communities Block 1216 as shown in FIG. 12D. Communities Block 1216 allows family and friends to post comments after properly logging in.

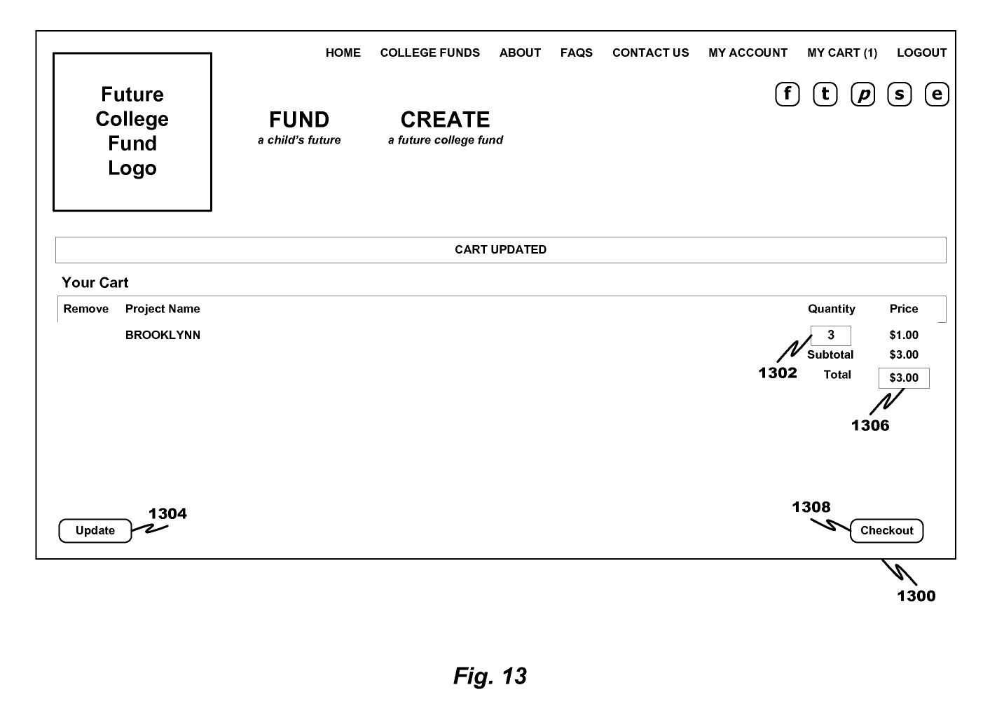

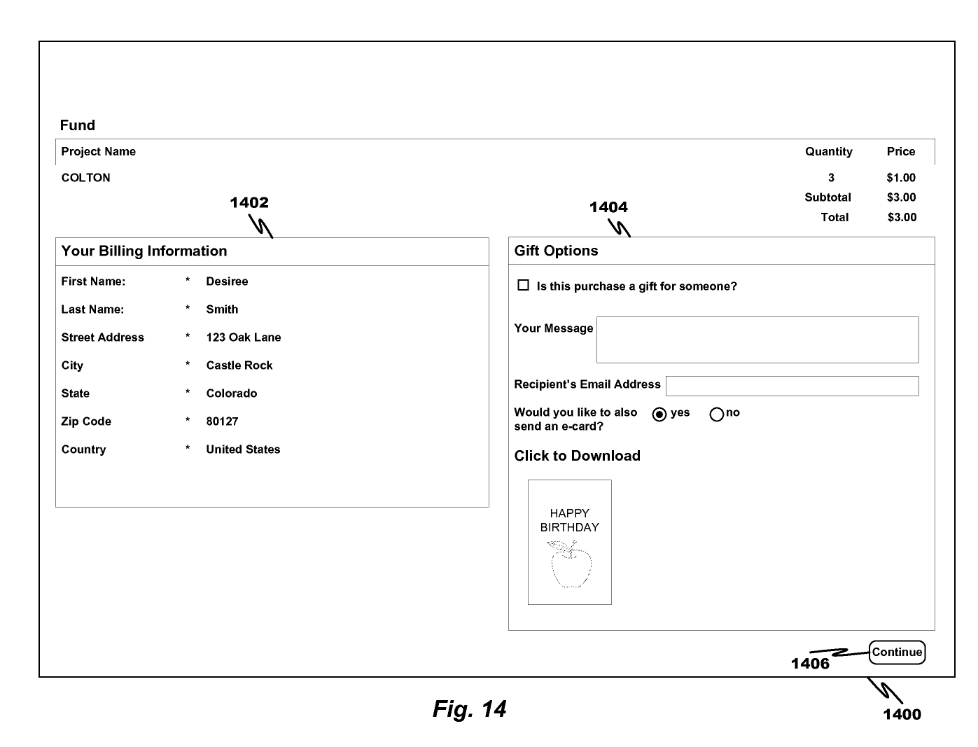

Clicking on Fund It! Link 1218 returns Your Cart Page 1300 shown in FIG. 13. Fund It! Link 1218 has a default amount of $1. The default amount may be set to $2, $5, $10, or any other amount set by the user. Donors may make contributions in multiples of this default amount. In Quantity Box 1302 the user or donor can enter the number of one dollar donations that the user or donor wishes to make. After clicking on Update Button 1304, the total donation amount is calculated and displayed in Total Box 1306. When the user or donor is ready to check out, clicking on Checkout Button 1308 returns Your Billing Information Page 1400 shown in FIG. 14.

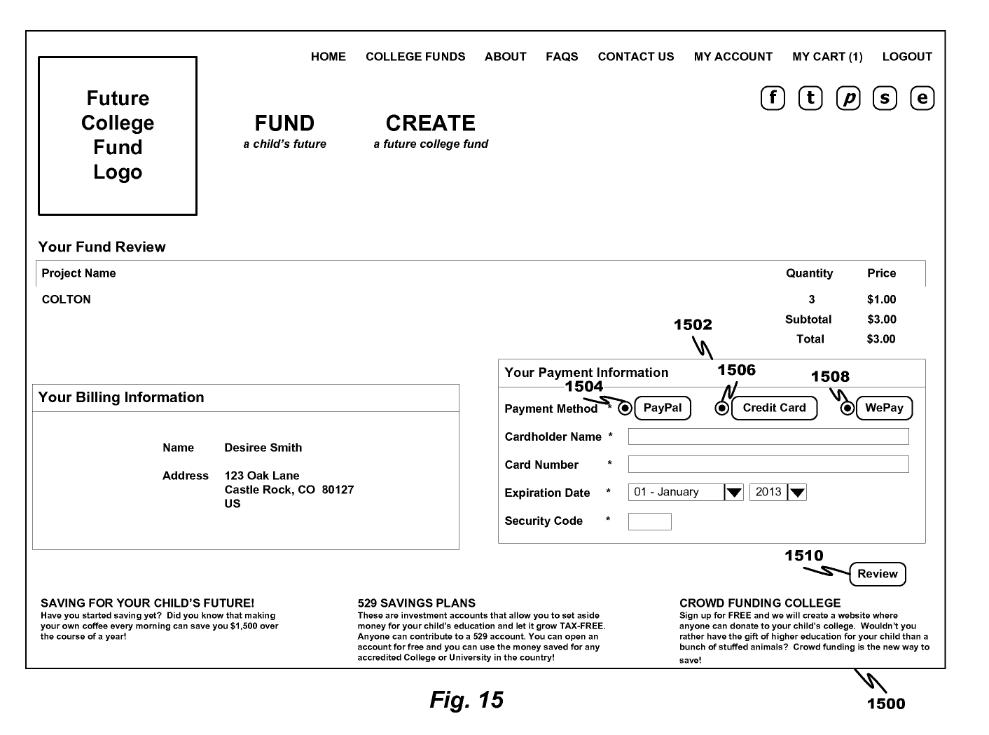

Your Billing Information Block 1402 shown in FIG. 14 is populated with account information derived from the logged in user or donor (FIG. 2). Gift Options Block 1404 has a number of text entry boxes that the user can fill in by clicking in each box and typing in the information requested, including, but not limited to: Is this purchase a gift for someone?; Your Message; Recipients Email Address; and Would you like to also send an e-card? Once the user has finished entering information in Gift Options Block 1404, clicking on Continue Button 1406 will return Your Fund Review Page 1500 as shown in FIG. 15.

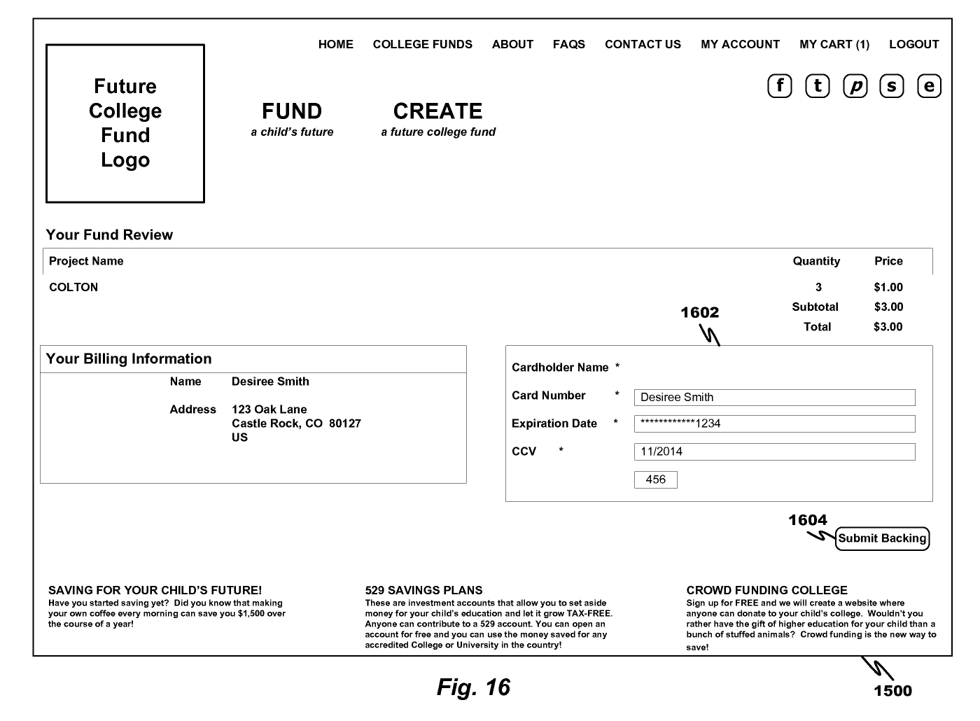

Payment Information Block 1502 has three different payment methods that can be selected. By clicking on Radio Button 1504 the user or donor can make their donation with PayPal. After selecting Radio Button 1504, the user or donor clicks on Review Button 1510 which will return the PayPal website page to the display device (not shown). The user or donor completes the information required by the PayPal website and when finished, Your Fund Review Page 1500 is redisplayed on the display device as shown in FIG. 16.

The user or donor may alternatively select Radio Button 1508 and then click on Review Button 1510 which will return the WePay website page to the display device (not shown). The user or donor completes the information required by the WePay website and when finished, Your Fund Review Page 1500 is redisplayed on the display device as shown in FIG. 16.

The user or donor may alternatively select Radio Button 1506 to make their donation with a credit card, which is the option shown selected in FIG. 15. Payment Information Block 1502 has a number of text entry boxes that the user can fill in by clicking in each box and typing in the information requested, including, but not limited to: Cardholder Name; Card Number; Expiration Date (selectable from pull-down lists); and Security Code. After completing this information, the user or donor clicks on Review Button 1510. In the background, prior to redisplaying Your Fund Review Page 1500, the validity of the credit card number, cardholder name, expiration date, and security code are verified through the online credit card verification services. After verification, Your Fund Review Page 1500 is redisplayed on the display device as shown in FIG. 16. Other suitable payment means may be incorporated into the functionality of Payment Information Block 1502 of Your Fund Review Page 1500.

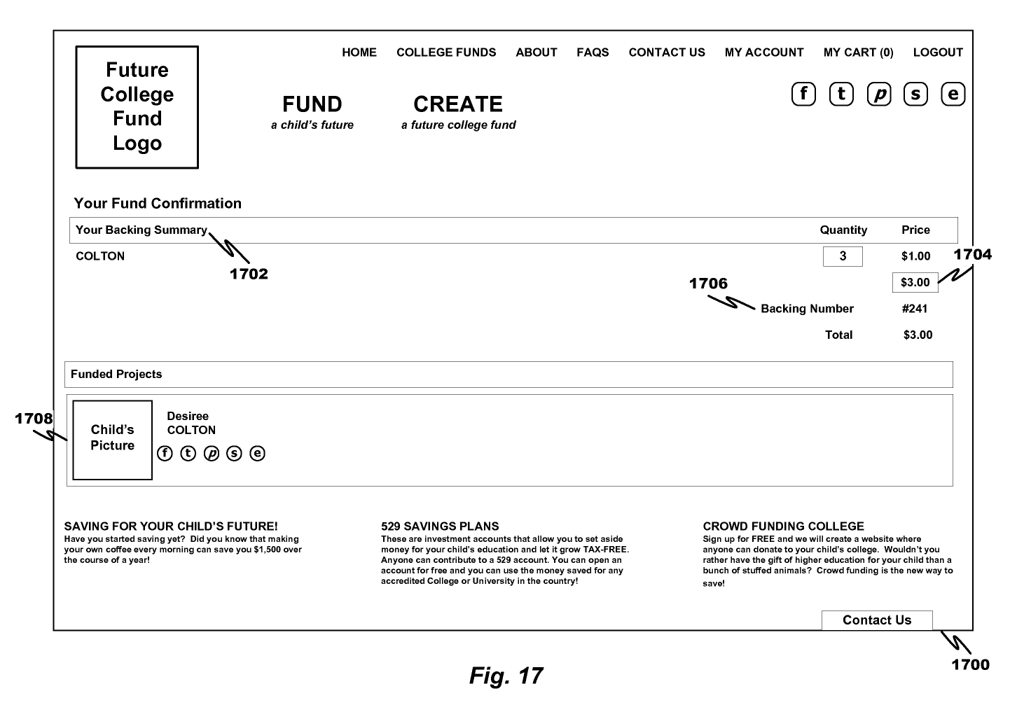

In FIG. 16, Your Payment Information Block 1602 displays the credit card information that was verified. The user or donor clicks on Submit Backing Button 1604 to consummate the donation, resulting in the credit card being charged, or execution of the transaction via PayPal or WePay if those options were chosen. In all three options, the transaction is processed through the user's PayPal or WePay account. Your Fund Confirmation Page 1700 is returned as shown in FIG. 17 after Submit Backing Button 1604 has been clicked.

In FIG. 17, Your Backing Summary Block 1702 indicates the Donation Amount 1702 and Backing Number 1706. Backing Number 1706 is used in an invoicing system to identify which account has been backed with a donation and the amount of the donation. Funded Projects Block 1708 indicates the future college fund project to which the user or donor has just contributed.

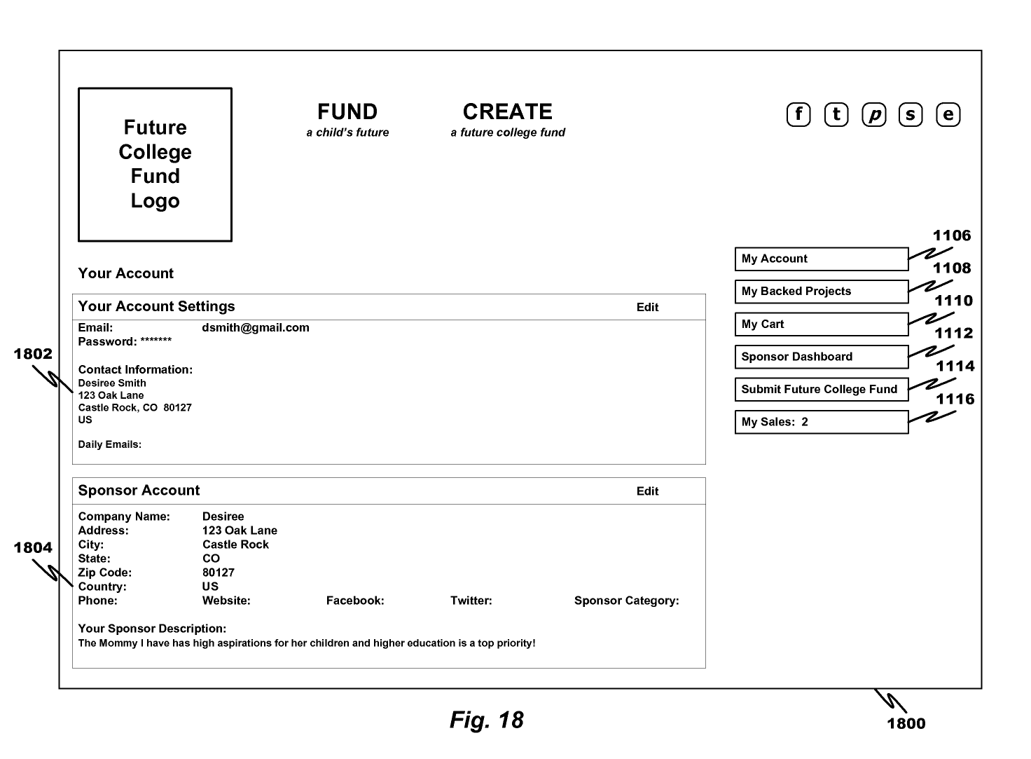

Referring back to FIG. 3 and FIG. 11A, clicking on My Account Link 310 in FIG. 3 or My Account Link 1106 in FIG. 11A returns Your Account Page 1800 as shown in FIG. 18. Your Account Settings Block 1802 shows the account settings currently in place for the user. Sponsor Account Block 1804 shows the details of the user that is sponsoring the beneficiary, such as their contact information. The user/sponsor can also add a description about themselves.

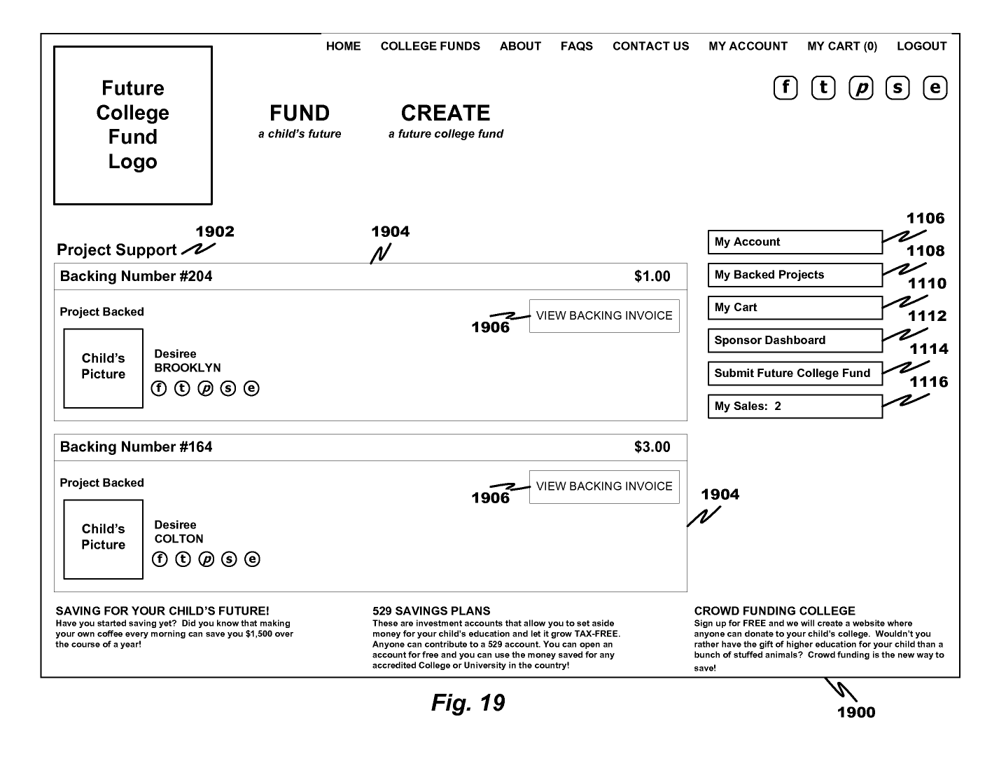

Clicking on My Backed Projects Link 1108 in FIG. 11A or in FIG. 18 returns Project Support Page 1900 as shown in FIG. 19. Project Support 1902 shows the project(s) backed. Each Project Backed 1904 shows, but is not limited to, the following information: the backing number; the name of the project backed; and the amount of the donation backing the project. Each Project Backed 1904 has a View Backing Invoice Link 1906 that when clicked on will display the details of the donation transaction (not shown).

Clicking on My Cart Link 1110 in FIG. 11A or in FIG. 18 returns a web page (not shown) that will show any pending donations to one or more projects. The donor may select one or more future college fund projects to donate to, and as each one is selected, it is added to a cart. When the user or donor is done selecting projects, clicking on a checkout button will return Your Fund Review Page 1500 shown in FIG. 15, and the user or donor can continue with selecting the payment method.

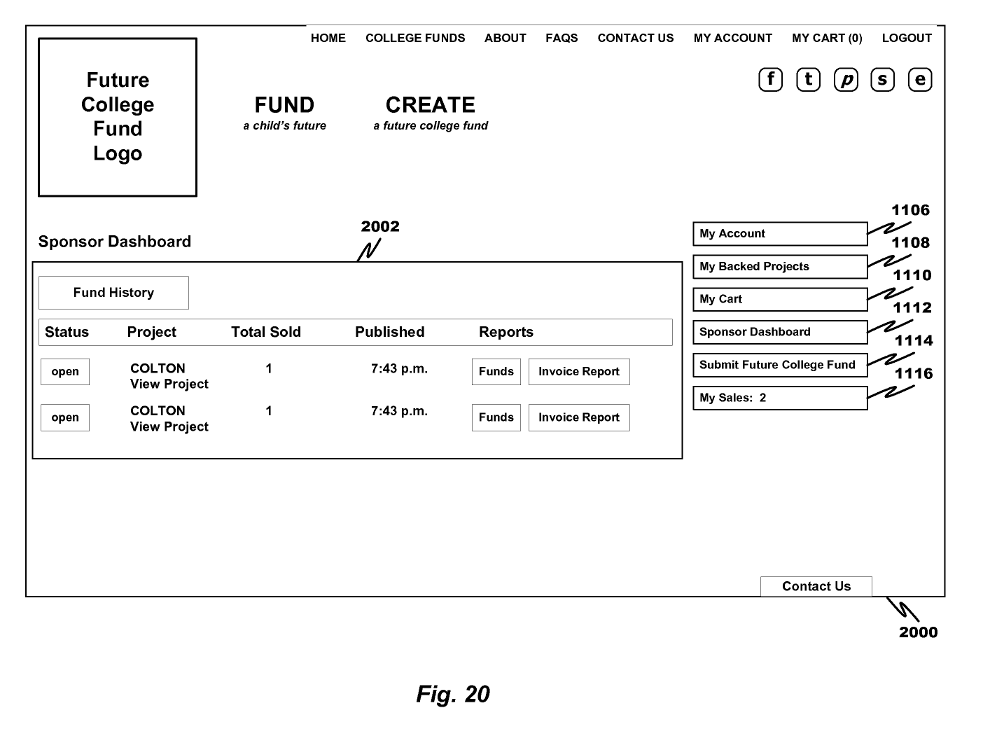

Clicking on Sponsor Dashboard Link 1112 in FIG. 11A or in FIG. 18 returns Sponsor Dashboard Page 2000 as shown in FIG. 20. Fund History Block 2002 shows all of the future college fund accounts that the user has opened up. Fund History Block 2002 shows, but is not limited to, the following information about each project: Status; Project Name; Total Sold; Published Date; and Reports, such as Funds in the Account, and Invoice Report. Total Sold is the quantity of funders or backers that have donated to the beneficiary. Published Date is the date that the beneficiary was funded for the first time.

Clicking on Submit Future College Fund Link 1114 in FIG. 11A or in FIG. 18 returns Submit Future College Fund Page 1100 as shown in FIGS. 11A and 11B.

Sales Link 1116 in FIG. 11A or in FIG. 18 shows the total number of donations received for all beneficiaries being sponsored by the user.

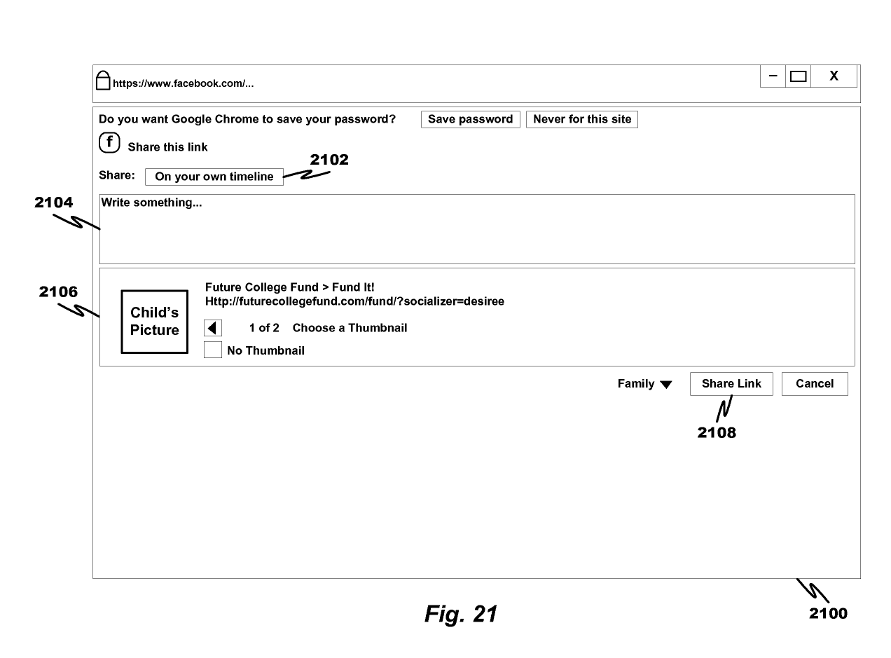

Referring now back to FIG. 1, clicking on Facebook Icon 126 will take the user to a Facebook login page (not shown). After the user logs in to their Facebook account, Facebook Page 2100 as shown in FIG. 21 is returned. The user can click on Dropdown Menu 2102 and choose one of the following share options: On your own timeline; On a friend's timeline; In a group; or In a private message. The user can also type in a message in Text Box 2104, choose or not choose a thumbnail in Thumbnail Block 2106, and then click on Share Link 2108 to share the link to the future college fund website on Facebook.

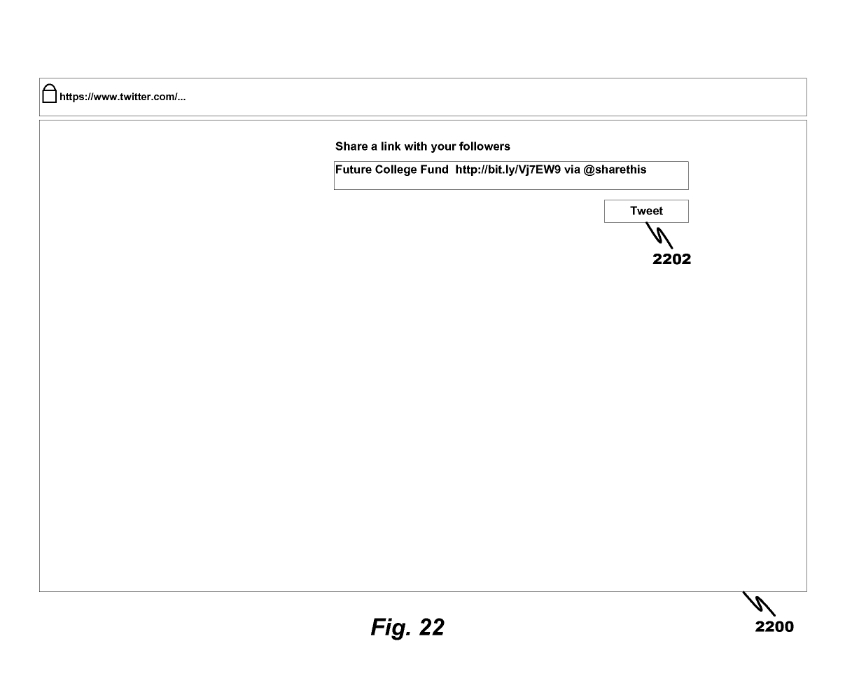

Clicking on Twitter Icon 128 will take the user to a Twitter login page (not shown). After the user logs in to their Twitter account, Twitter Page 2200 as shown in FIG. 22 is returned. The user can click on Tweet Button 2202 to share the future college fund website with their followers.

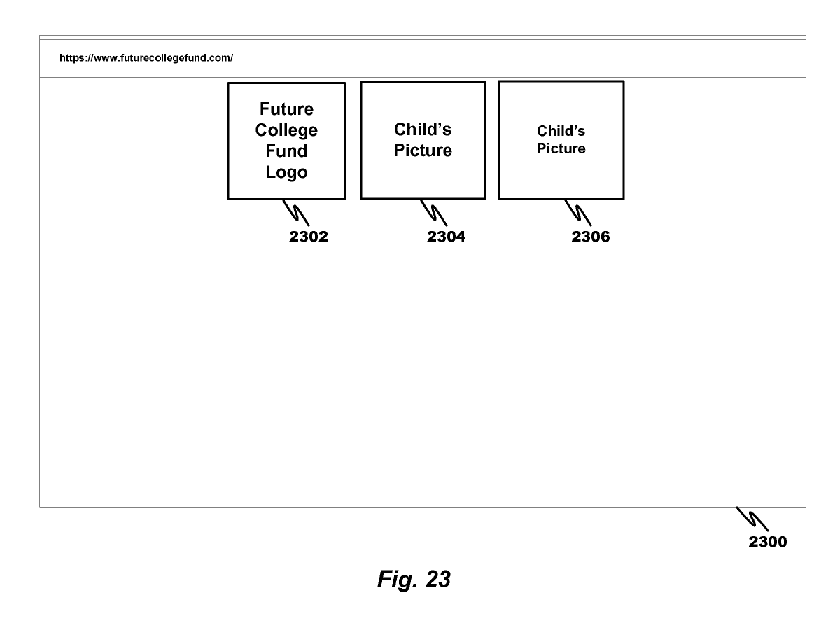

Clicking on Pinterest Link 130 will return Pinterest Page 2300 as shown in FIG. 23. The user can click on any of the Images 2302, 2304, or 2306 to pin the image to their Pinterest account.

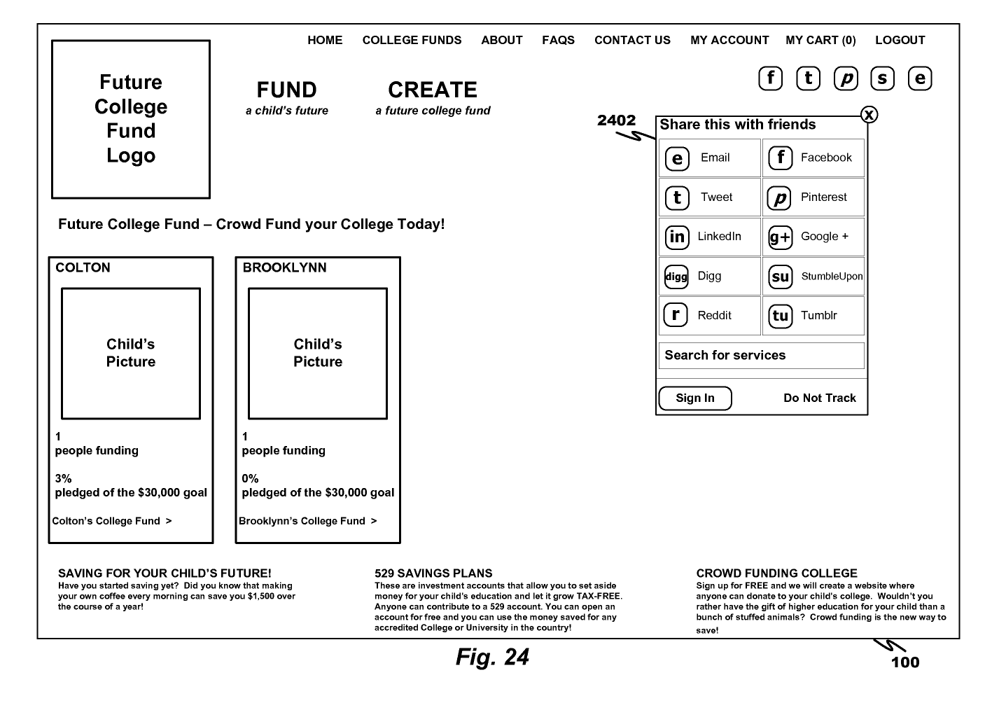

Clicking on Share Link 132 will reveal Share Dropdown Box 2402 on Home Page 100 as shown in FIG. 24. The user can click on any of the links shown to access the particular share option.

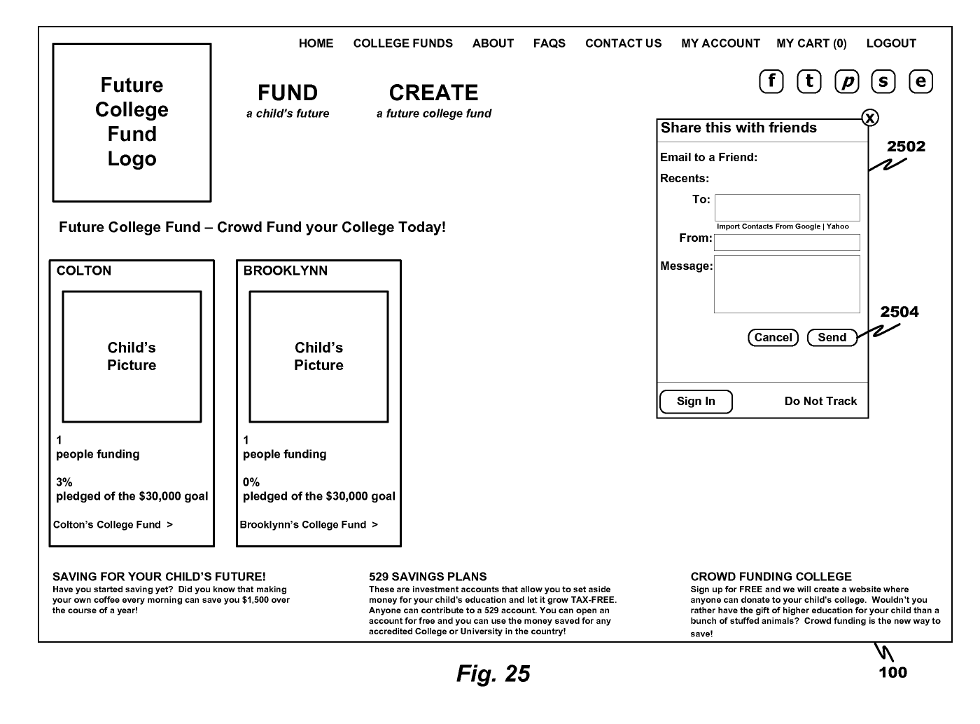

Clicking on Email Link 134 will reveal Email Dropdown Box 2502 on Home Page 100 as shown in FIG. 25. Email Dropdown Box 2502 has a number of text entry boxes that the user can fill in by clicking in each box and typing in the information requested, including To; From; and Message. Clicking on Send Button 2504 will send the email. A link to the future college fund website is embedded in the email so the recipient of the email can click on the link and be taken to the website.

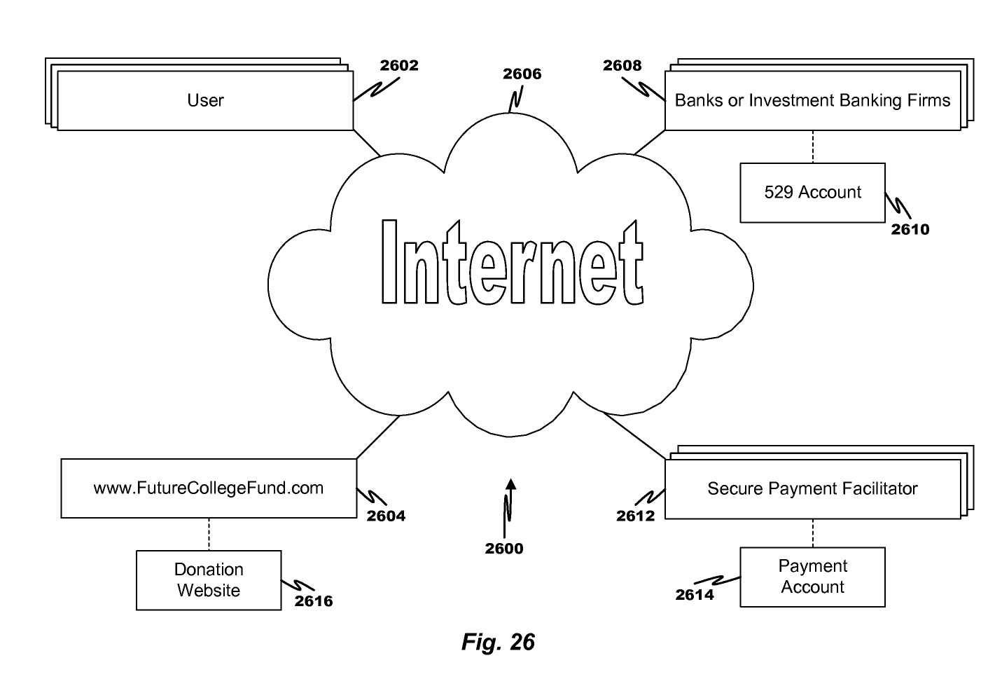

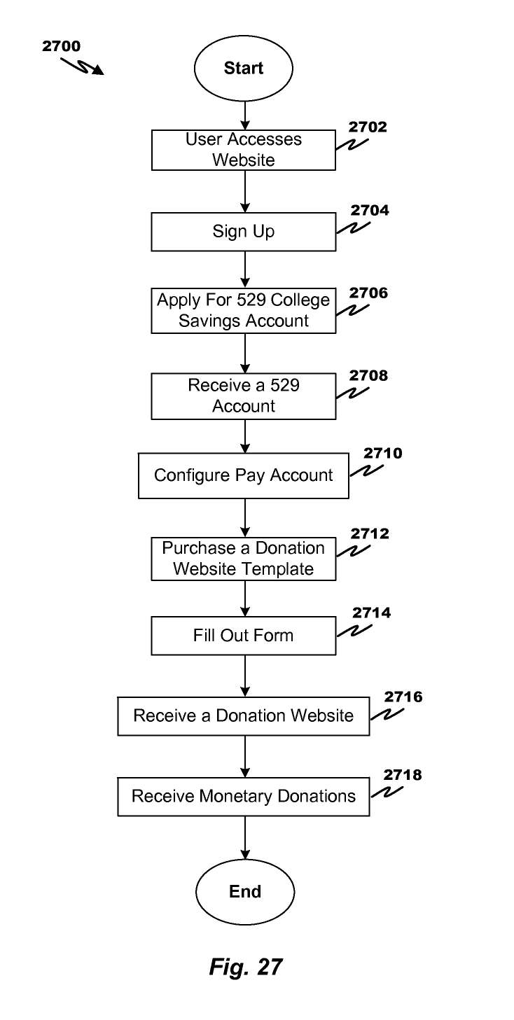

FIG. 26 shows a schematic/block diagram of an operating environment of an embodiment of the automated future college fund of the present disclosure. FIG. 27 shows a flow diagram of a method of implementing an embodiment of the automated future college fund of the present disclosure within the operating environment of FIG. 26. Referring now to FIGS. 26 and 27, the Method 2700 starts in Step 2702 when, within Operating Environment 2600, User 2602 accesses www.FutureCollegeFund.com Website 2604 through the Internet 2606. In Step 2704 User 2602 signs up and registers utilizing the functionality built into Website 2604 (see FIGS. 1-25). The sign up process will require at least an email address and a user name selected by User 2602. If approved, an email is sent to User 2602 from Website 2604 indicating that their submission has been approved and that a donation website has been set up. In the email, the URL for the donation website is included, having the form of www.futurecollegefund.com/“Child'sName”. User 2602 receives their user name and password via email to access Website 2604 since in one embodiment it is a secure member's only website.

In Step 2706, Website 2604 supplies User 2602 with 529 savings account information and recommends one or more 529 plans. If User 2602 does not already have a 529 savings account, or if the 529 savings account already secured is not compatible with Operating Environment 2600, User 2602 applies online through the Internet 2606 to an online application process made available by one or more Banks 2608, which is external from Website 2604, to set up one or more 529 accounts with a Bank 2608 for one or more eligible beneficiaries, such as a child, grandchild, or friend. Alternatively, User 2602 can apply in person at a participating bank to obtain a 529 savings account. In Step 2708 User 2602 receives a 529 Account 2610 from Bank 2608.

In Step 2710, User 2602 sets up Payment Account 2614 with Secure Payment Facilitator 2612, such as WePay or PayPal or similar entity, according to instructions from Website 2604 if User 2602 does not already have an existing account of this type. The 529 Account 2610 is added to Payment Account 2614 of User 2602 using Bank 2608 routing number and new 529 Account(s) 2610 and the email address that User 2602 provided when setting up Payment Account 2614 with Secure Payment Facilitator 2612.

In Step 2712, User 2602 purchases a website template from Website 2604. In Step 2714 User 2602 fills out a form on Website 2604 for Donation Website 2616 with the beneficiary's name and optionally uploads a photo(s) of the beneficiary and the email address for Payment Account 2614.

In step 2716, User 2602 receives Donation Website 2616 with a URL of the form www.futurecollegefund.com/“Child'sName” and hosted by FutureCollegeFund.com. Website 2604 links Donation Website 2616 to 529 Account 2610 with Bank 2608 through Secure Payment Facilitator 2612 via Internet 2606. The website has the beneficiary's photo(s) (if supplied by User 2602), beneficiary's name, and a donation button provisioned on Donation Website 2616 linked to the beneficiary's 529 Account 2610 through Secure Payment Facilitator 2612. User 2602 may take various steps to disseminate the URL for Donation Website 2616 through various social media or any other available avenues.

In Step 2718, the beneficiary of User 2602 can now receive monetary donations from anyone, such as family members and friends, through Donation Website 2616 through the donation button (see Submit Backing Button 1604, FIG. 16) linked to the beneficiary's 529 Account 2610 via Secure Payment Facilitator 2612. Money can now be automatically donated to 529 Account 2610 with the click of a donation button from Donation Website 2616. Step 2718 may be repeated numerous times to receive multiple contributions from multiple donors.

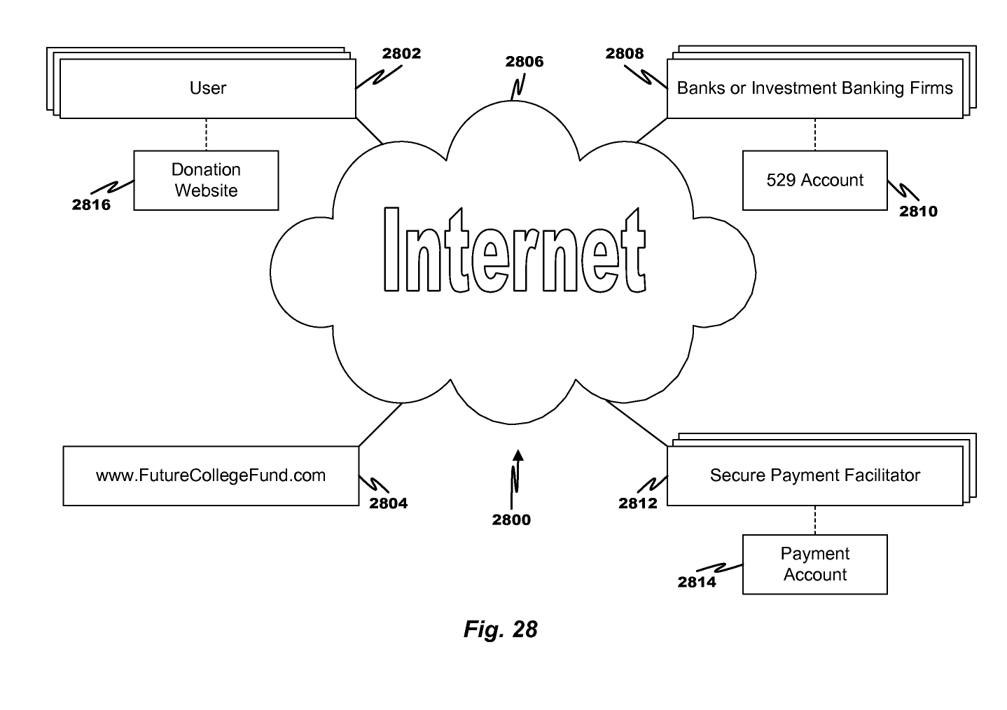

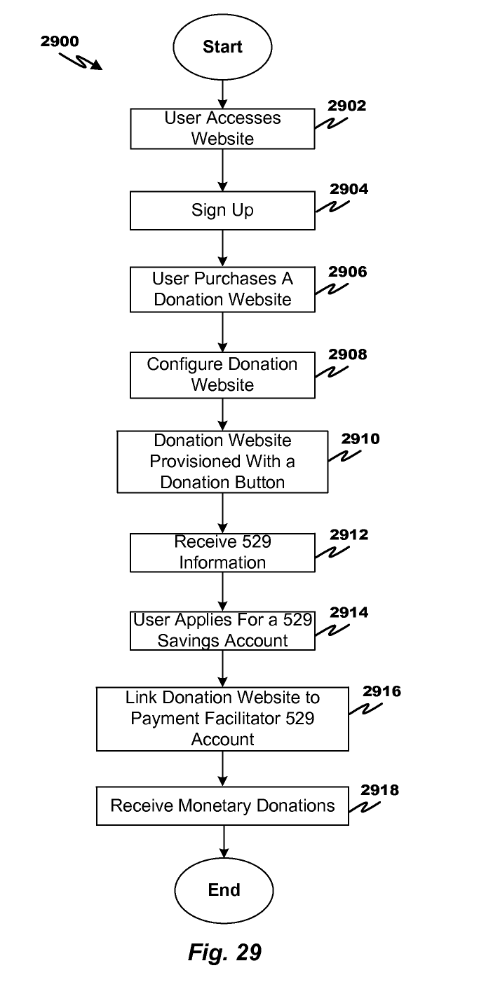

FIG. 28 shows a schematic/block diagram of an operating environment of an embodiment of the automated future college fund of the present disclosure. FIG. 29 shows a flow diagram of a method of implementing an embodiment of the automated future college fund of the present disclosure within the operating environment of FIG. 28. Referring now to FIGS. 28 and 29, the Method 2900 starts in Step 2902 when, within Operating Environment 2800, User 2802 accesses www.FutureCollegeFund.com Website 2804 through the Internet 2806. In Step 2904 the customer signs up for free or for a fee and registers utilizing the functionality built into Website 2804 (see FIGS. 1-25).

In Step 2906, User 2802 purchases or receives Donation Website 2816 that chooses from template designs or that User 2802 designs him or herself. Custom design options and domain names are made available by Website 2804 to User 2802 for a fee. Hosting for Donation Website 2816 is secured by User 2802.

In Step 2908, User 2802 adds the beneficiary's name and may add the beneficiary's photo(s) to Donation Website 2816 and it is linked to the email address of User 2802 for Payment Account 2814 of Secure Payment Facilitator 2812 (such as WePay or PayPal or similar entity) through a fillable form on Website 2804. In Step 2910 User 2802 now has Donation Website 2816 derived from Website 2804 with a unique URL such as vvww.futurecollegefund.com/“Child'sName” provisioned with a donation button (see Submit Backing Button 1604, FIG. 16) enabled on Donation Website 2816. In Step 2912 User 2802 receives information on 529 accounts or college investment accounts from Website 2804 with some recommended banks or investment firms to review, such as Bank 2808.

In Step 2914 User 2802 applies for 529 Account 2810 which is a 529 college savings account, custodial savings account, or similar account through Bank 2808. Through the application process for Bank 2808, User 2802 receives 529 Account 2810 from Bank 2808. In Step 2916 User 2802 then receives information from Website 2804 on how to link Donation Website 2816 through Payment Account 2814 of Secure Payment Facilitator 2812 to 529 Account 2810 of Bank 2808. In Step 2918 Donation Website 2816 can now receive donations through the click of a donation button which is linked to 529 Account 2810 through Payment Account 2814 of Secure Payment Facilitator 2812. Step 2918 may be repeated numerous times to receive multiple contributions from multiple donors.

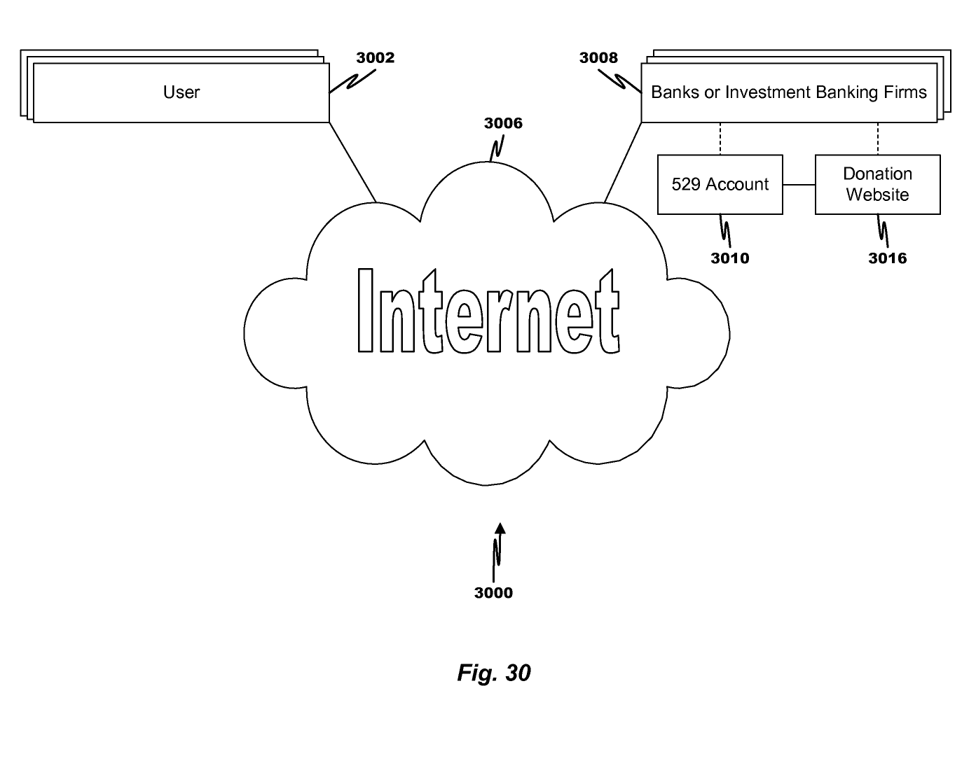

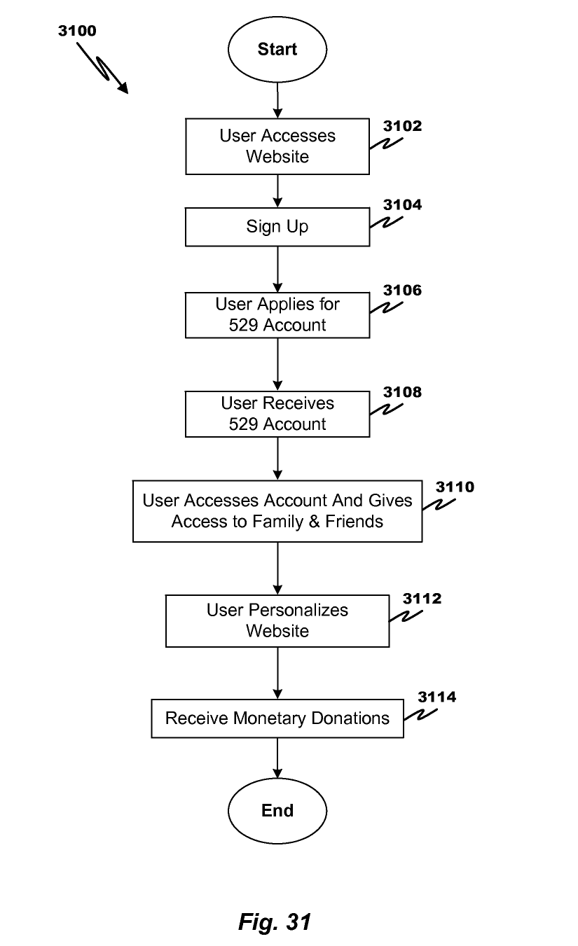

FIG. 30 shows a schematic/block diagram of an operating environment of an embodiment of the automated future college fund of the present disclosure. FIG. 31 shows a flow diagram of a method of implementing an embodiment of the automated future college fund of the present disclosure within the operating environment of FIG. 30. Referring now to FIGS. 30 and 31, the Method 3100 starts in Step 3102 when, within Operating Environment 3000, User 3002 accesses a website of Bank 3008. In Step 3104 User 3002 logs in, or signs up, through the Internet 3006 with Bank 3008 that has college investment options. In Step 3106, User 3002 applies for a college savings account and/or a 529 account for their beneficiary through an online application process offered by Bank 3008 through its website. In Step 3108 User 3002 receives an approval message from Bank 3008 through its website. In Step 3110, User 3002 accesses 529 Account 3010 online through Donation Website 3016 set up and hosted by Bank 3008 through its website. User 3002 then gives family and friends access online to Donation Website 3016. Through a donation button enabled on Donation Website 3016 by Bank 3008, the family and friends can make contributions to 529 Account 3010 by clicking on the donation button.

In Step 3112, User 3002 may be able to personalize Donation Website 3016 with the beneficiary's photo(s) or other information through a fillable form on the website of Bank 3008. In Step 3114, User 3002 can continue to share access to Donation Website 3016 and the beneficiary's 529 Account 3010 with friends and family who can make donations or contributions to the savings account via the donation button enabled on Donation Website 3016.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A method for making contributions to a college savings account, the method comprising the steps of:
(a) enabling Internet access to a future college fund website;
(b) receiving sign up and registration information from a user through the future college fund website;
(c) receiving a request from the user for a website template through the future college fund website;
(d) receiving information through an online form through the future college fund website, wherein the information comprises at least a beneficiary name and an email address associated with a payment account associated with a secure payment facilitator; and
(e) provisioning a donation website for the user associated with the beneficiary name, wherein the donation website is hosted through the future college fund website and is linked via the Internet to a college savings account at a financial institution secured by the user through the payment account associated with the secure payment facilitator.

2. The method according to claim 1 further comprising the step of:
receiving input on a donation button provisioned on the donation website, wherein funds are transferred to the college savings account through the payment account associated with the secure payment facilitator

3. The method according to claim 2 further comprising the step of:
receiving input on the donation button from third parties who have been sent the URL for the donation website by the user through various social media or any other available avenues.

4. The method according to claim 1 wherein receiving step (b) further comprises the step of:
receiving at least an email address and a user name selected by the user.

5. The method according to claim 1 further comprising the step of:
sending by the future college fund website an email to the user indicating that the sign up and registration information has been approved, the donation website has been set up, and includes the URL for the donation website.

6. The method according to claim 3 further comprising the step of:
sending by the future college fund website an email to the user with the user's name and password for accessing the future college fund website.

7. The method according to claim 1 further comprising at least one of the steps of:
sending by the future college fund website information about college savings plans and at least one recommendation for a particular college savings plan.

8. The method according to claim 1 wherein receiving step (d) further comprises the step of:
receiving at least one photograph of the beneficiary for inclusion in the donation website.

9. The method according to claim 1 wherein the college savings account at the financial institution was secured by the user prior to said receiving step (b).

10. The method according to claim 1 wherein the payment account at the secure payment facilitator was secured by the user prior to said receiving step (b).

11. The method according to claim 1 further comprising the step of:
provisioning the donation website with an option for selecting to send an email to the user with a personal message and an option for selecting to send an e-card to the user.

12. The method according to claim 1 further comprising the step of:
provisioning the donation website with an option for selecting a report on funds in the college savings account and an option for selecting a report on fund invoices.

13. A method for making contributions to a college savings account, the method comprising the steps of:
(a) enabling Internet access to a future college fund website;
(b) receiving sign up and registration information from a user through the future college fund website;
(c) receiving a request from the user for a donation website through the future college fund website, wherein hosting for the donation website is secured by the user;
(d) delivering a website template to the user wherein the website template is provisioned with a donation button, wherein the donation button is operable to be linked via the Internet to a college savings account at a financial institution through a payment account with a secure payment facilitator of the user and an email address of the user associated with the payment account;
(e) delivering from the future college fund website over the Internet to the user information on college savings accounts; and
(f) delivering from the future college fund website over the Internet to the user information on how to link the donation website through the user's payment account with the secure payment facilitator to the college savings account offered by the financial institution.

14. The method according to claim 13 further comprising the step of:
provisioning a fillable form on the future college fund website wherein the user can add a beneficiary's name and a photo of the beneficiary and link the payment account of the secure payment facilitator and the email address associated with the payment account to the donation website.

15. The method according to claim 13 further comprising the step of:
receiving input on the donation button from third parties who have been sent the URL for the donation website by the user through various social media or any other available avenues.

16. The method according to claim 13 further comprising the step of:
provisioning the website template with an option for selecting to send an email to the user with a personal message and an option for selecting to send an e-card to the user.

17. A method for making contributions to a college savings account, the method comprising the steps of:
(a) enabling Internet access to a financial institution website;
(b) receiving sign up and registration information from a user through the financial institution website;
(c) receiving an application from the user for a college savings account for a beneficiary through an online application process provisioned through the financial institution website;
(d) sending an approval email to the user from the financial institution website;
(e) provisioning a donation website for the user associated with the beneficiary, wherein the donation website is hosted by the financial institution website and is linked to the college savings account at the financial institution; and
(f) receiving input on the donation button provisioned on the donation website, wherein funds are transferred to the college savings account through the donation website to the college savings account at the financial institution.

18. The method according to claim 17 further comprising the step of:
receiving input on the donation button from third parties who have been sent the URL for the donation website by the user through various social media or any other available avenues.

19. The method according to claim 17 further comprising the step of:
provisioning a fillable form on the financial institution website wherein the user can add a beneficiary's name and a photo of the beneficiary to the donation website.

20. The method according to claim 17 further comprising the step of:
provisioning the donation website with an option for selecting to send an email to the user with a personal message and an option for selecting to send an e-card to the user.
